(19) United States
(12) Patent Application Publication
(10) Pub. No.: US 2021/0231507 A1
(43) Pub. Date: Jul. 29, 2021

(54) MEASURING APPARATUS, AND MEASURING METHOD

(71) Applicant: Pixie Dust Technologies, Inc., Tokyo (JP)

(72) Inventors: Yoichi OCHIAI, Chiyoda-ku (JP); Takayuki HOSHI, Chiyoda-ku (JP); Arata TAKAHASHI, Chiyoda-ku (JP)

(73) Assignee: Pixie Dust Technologies, Inc., Tokyo (JP)

(21) Appl. No.: 17/229,120

(22) Filed: Apr. 13, 2021

Related U.S. Application Data
(63) Continuation of application No. PCT/JP2019/033965, filed on Aug. 29, 2019.

(30) Foreign Application Priority Data
Nov. 30, 2018 (JP) 2018-225630
Feb. 12, 2019 (JP) 2019-022911

(51) Int. Cl. G01K 11/24; G01P 5/24; G01P 13/04

(52) U.S. Cl. CPC G01K 11/24; G01P 13/045; G01P 5/245

(57) ABSTRACT

A measuring apparatus includes a determining unit configured to determine propagation paths through which acoustic waves propagate. The acoustic waves are transmitted from one or more transmitters, pass through a predetermined region and are received by one or more receivers. The measuring apparatus includes a controlling unit configured to control the transmitters such that acoustic waves are transmitted and propagate through the propagation paths determined by the determining unit. The measuring apparatus includes an identifying unit configured to identify each of propagation times required for each of the acoustic waves transmitted in response to the control by the controlling unit to propagate each of the propagation paths. The measuring apparatus includes a measuring unit configured to measure an air characteristic of the predetermined region based on the propagation times identified by the identifying unit and length of the propagation paths.

### FIELD

The present invention relates to a temperature measuring apparatus, and a measuring method.

### BACKGROUND

It is possible to measure the temperature in space from the propagation time of acoustic waves using the principle that the velocity of acoustic waves propagating in the air varies according to temperature.

For example, JP-A-2014-095600 discloses a technique of measuring the temperature of a space from the propagation time of ultrasonic waves by arranging a plurality of sensor units capable of transmitting and receiving ultrasonic waves in the space.

In JP-A-2014-095600, since the ultrasonic wave has no directivity, the sensor unit receives not only a desired ultrasonic wave component but also a component of the ultrasonic wave reflected by a reflecting member (e.g., a wall) existing in a space. Therefore, there is a possibility that ultrasonic waves are erroneously detected.

That is, conventionally, the S/N ratio in the case of measuring the temperature of the space is low. As a result, the accuracy of the measurement result of the temperature of the space is reduced.

### SUMMARY

In one aspect of the present invention is a measuring apparatus.

The measuring apparatus includes a determining unit configured to determine propagation paths through which acoustic waves propagate, wherein the acoustic waves are transmitted from one or more transmitters, pass through a predetermined region and are received by one or more receivers.

The measuring apparatus includes a controlling unit configured to control the transmitters such that acoustic waves are transmitted and propagate through the propagation paths determined by the determining unit.

The measuring apparatus includes an identifying unit configured to identify each of propagation times required for each of the acoustic waves transmitted in response to the control by the controlling unit to propagate each of the propagation paths.

The measuring apparatus includes a measuring unit configured to measure an air characteristic of the predetermined region based on the propagation times identified by the identifying unit and length of the propagation paths.

### BRIEF DESCRIPTION OF THE DRAWINGS

FIG. 1 is a block diagram showing a configuration of a measurement system of the first embodiment.

FIG. 2 is a block diagram showing a detailed configuration of the measurement system of the first embodiment.

FIG. 3A is a schematic diagram showing a configuration of an acoustic wave transmitter of the first embodiment.

FIG. 3B is a schematic diagram showing a configuration of an acoustic wave transmitter of the first embodiment.

FIG. 4A is a schematic diagrams showing a configuration of an acoustic wave receiver of the first embodiment.

FIG. 4B is a schematic diagrams showing a configuration of an acoustic wave receiver of the first embodiment.

FIG. 5 is an explanatory diagram of an outline of the first embodiment.

FIG. 6 is a diagram showing the data structure of the spatial data table of the first embodiment.

FIG. 7 is a diagram showing a data structure of the sensor data table of the first embodiment.

FIG. 8 is a diagram showing a data structure of the path data table of the first embodiment.

FIG. 9 is a diagram showing a data structure of the mesh data table of the first embodiment.

FIG. 10 is an explanatory diagram of a filter according to the first embodiment.

FIG. 11 is a diagram showing an example of a sensor arrangement according to the first embodiment.

FIG. 12 is a flowchart of the processing of the temperature measurement of the first embodiment.

FIG. 13 is a detailed flowchart of the calculation of the path temperature of FIG. 12.

FIG. 14 is a diagram showing an example of a screen displayed in the process of FIG. 12.

FIG. 15A is a schematic diagram showing a configuration of an acoustic wave transmitter of the second embodiment.

FIG. 15B is a schematic diagram showing a configuration of an acoustic wave transmitter of the second embodiment.

FIG. 16 is a diagram showing a data structure of the path data table of the second embodiment.

FIG. 17 is an explanatory view of a transmission angle of the second embodiment.

FIG. 18 is a diagram showing an example of the sensor arrangement of the second embodiment.

FIG. 19 is a detailed flowchart of the calculation of the path temperature of the second embodiment.

FIG. 20A is a schematic diagram showing a configuration of an acoustic wave transmitter and an acoustic wave receiver of Modification 1.

FIG. 20B is a schematic diagram showing a configuration of an acoustic wave transmitter and an acoustic wave receiver of Modification 1.

FIG. 21A is a schematic diagram showing a configuration of an acoustic wave transmitter and an acoustic wave receiver of Modification 4.

FIG. 21B is a schematic diagram showing a configuration of an acoustic wave transmitter and an acoustic wave receiver of Modification 4.

FIG. 22 It is an explanatory view of the principle of the Modification 4.

FIG. 23 is an explanatory view of an outline of a modification 5.

FIG. 24 is a flowchart of the processing of the temperature measurement of Modification 5.

FIG. 25 is a schematic diagram of acoustic wave transmitters and acoustic wave receivers of Modification 6.

FIG. 26 is a diagram showing an example of the sensor arrangement of Modification 8.

FIG. 27A is a diagram showing a configuration of an acoustic wave transmitter of Modification 9.

FIG. 27B is a diagram showing a configuration of an acoustic wave transmitter of Modification 9.

FIG. 28A is a diagram showing a configuration of an acoustic wave receiver of Modification 9.

FIG. 28B is a diagram showing a configuration of an acoustic wave receiver of Modification 9.

FIG. 29 is a diagram showing an outline of a first example of Modification 9.

FIG. 30A is a diagrams showing a configuration of a sensor unit of Modification 9.

FIG. 30B is a diagrams showing a configuration of a sensor unit of Modification 9.

FIG. 31 is a diagram showing an outline of a second example of Modification 9.

FIG. 32 is an explanatory view of a filter of Modification 10.

### DETAILED DESCRIPTION

Hereinafter, an embodiment of the present invention will be described in detail with reference to the drawings. In the drawings for explaining the embodiments, the same components are denoted by the same reference numerals in principle, and repetitive descriptions thereof are omitted.

### (1) First Embodiment

The first embodiment will be explained.

### (1-1) Configuration of the Measurement System

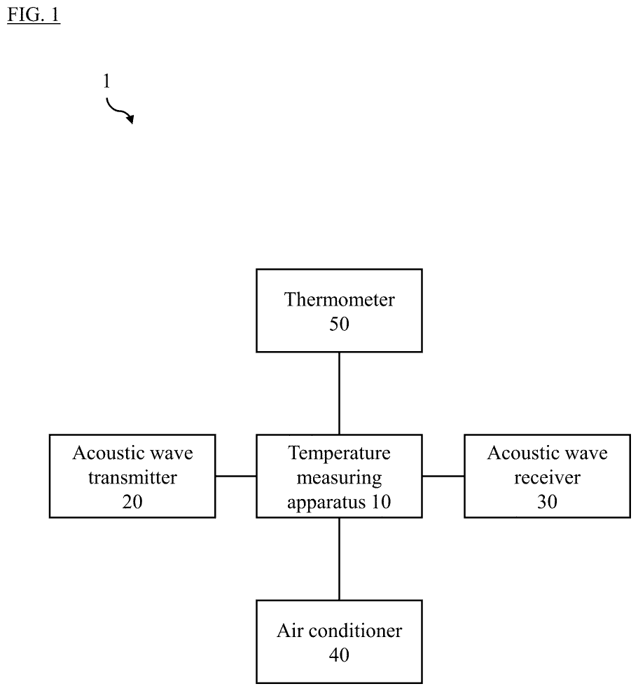

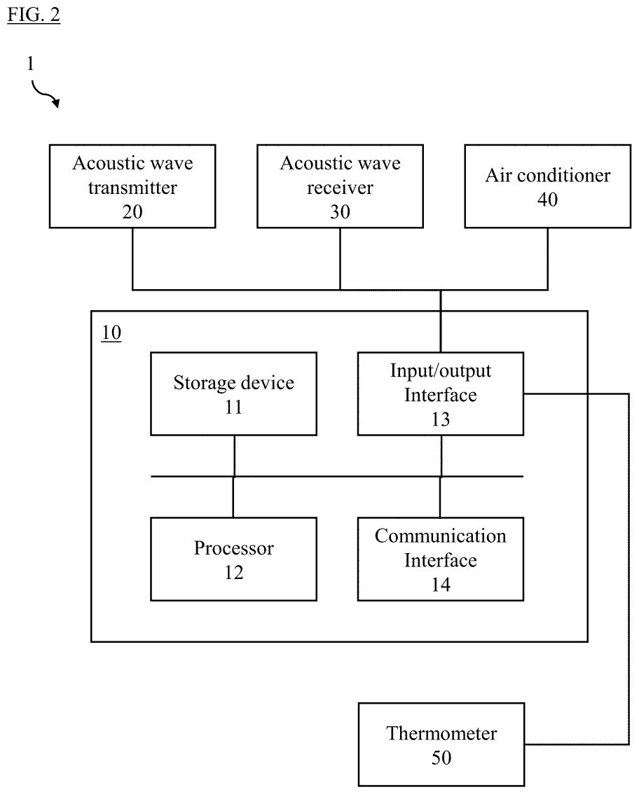

The configuration of the measurement system of the first embodiment will be described. FIG. 1 is a block diagram showing a configuration of a measurement system of the first embodiment. FIG. 2 is a block diagram showing a detailed configuration of the measurement system of the first embodiment.

As shown in FIGS. 1 and 2, the measurement system 1 includes a temperature measuring apparatus 10, an acoustic wave transmitter 20, an acoustic wave receiver 30, an air conditioner 40, a thermometer 50.

The temperature measuring apparatus 10 is connected the acoustic wave transmitter 20, the acoustic wave receiver 30, the air conditioner 40 are the thermometer 50.

The temperature measuring apparatus 10, the acoustic wave transmitter 20, the acoustic wave receiver 30, the air conditioner 40, and the thermometer 50 are disposed in the target space SP.

The temperature measuring apparatus 10 has the following functions:

Function of controlling the acoustic wave transmitter 20;

Function of acquiring received waveform data from the acoustic wave receiver 30;

Function of measuring the temperature distribution in the target space SP;

Function of controlling the air conditioner 40; and

Function of acquiring the reference temperature information relating to the measurement result of the temperature of the target space SP from the thermometer 50.

The temperature measuring apparatus 10 is, for example, a smart phone, a tablet terminal, or a personal computer.

The acoustic wave transmitter 20 is configured to transmit an ultrasonic beam having directivity (an example of an “acoustic wave”) in accordance with the control of the temperature measuring apparatus 10. The acoustic wave transmitter 20 is also configured to change the transmission direction of the ultrasonic wave.

The acoustic wave receiver 30 is configured to receive the ultrasonic beam transmitted from the acoustic wave transmitter 20 and generate received waveform data corresponding to the received ultrasonic beam. The acoustic wave receiver 30 is, for example, an omni-directional microphone or a directional microphone.

The air conditioner 40 is configured to adjust the temperature of the target space SP in accordance with the control of the temperature measuring apparatus 10.

The thermometer 50 is configured to measure the temperature (hereinafter referred to as “reference temperature”) of the target space SP.

### (1-1-1) Configuration of the Temperature Measuring Apparatus

The configuration of the temperature measuring apparatus 10 according to the first embodiment will be described.

As shown in FIG. 2, the temperature measuring apparatus 10 includes a storage device 11, a processor 12, an input/output interface 13, and a communication interface 14.

The storage device 11 is configured to store programs and data. The storage device apparatus 11 is, for example, a combination of ROM (Read Only Memory), RAM (Random Access Memory), and storage (e.g., flash memory or hard disk).

The program includes, for example, the following program:

Programming the Operating System (Operating System);

Program of an application that executes information processing (e.g., information processing for measuring the temperature distribution of the target space SP); and

Data on sound speed characteristics with respect to the speed of acoustic waves relative to the temperature of space.

The data includes, for example, the following data:

Database referenced in information processing; and

Data obtained by executing information processing (that is, the result of executing information processing).

The processor 12 is configured to realize the functions of the temperature measuring apparatus 10 by activating a program stored in the storage device 11. The processor 12 is an example of a computer.

The input/output interface 13 is configured to acquire a user instruction from an input device connected to the temperature measuring apparatus 10, and to output information to an output device connected to the temperature measuring apparatus 10.

The input device may be, for example, a keyboard, a pointing apparatus, a touch panel, or a combination thereof. The input device also includes a thermometer 50.

The output device is, for example, a display. The output device also includes an air conditioner 40.

The communication interface 14 is configured to control communication with an external apparatus (e.g., a server).

### (1-1-2) Configuration of the Acoustic Wave Transmitter

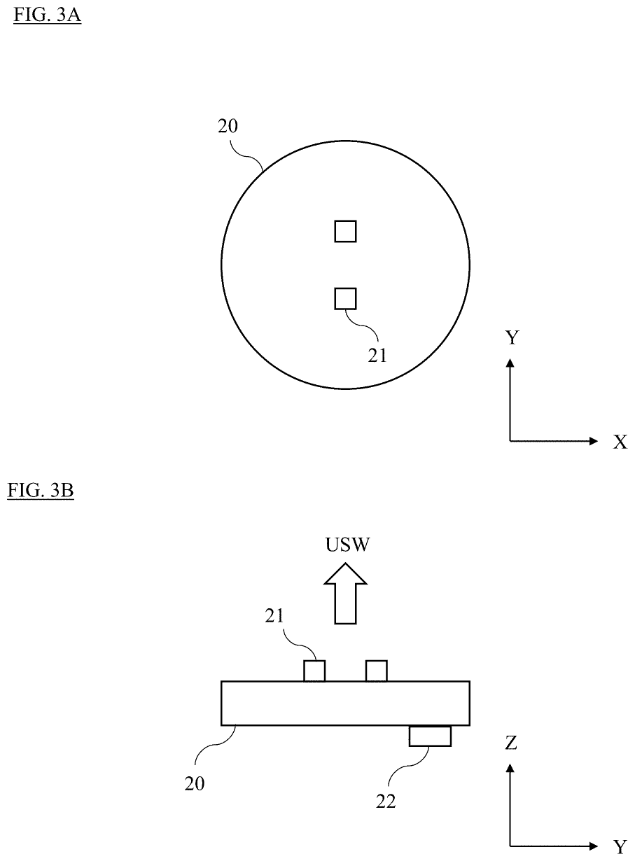

The configuration of the acoustic wave transmitter 20 of the first embodiment will be described. FIGS. 3A and 3B are schematic diagrams showing a configuration of an acoustic wave transmitter of the first embodiment.

As shown in FIG. 3A, the acoustic wave transmitter 20 includes a plurality of ultrasonic transducers (an example of an “oscillating element”) 21 and a control circuit 22.

As shown in FIG. 3B, the control circuit 22 oscillates the plurality of ultrasonic transducers 21 in accordance with the control of the temperature measuring apparatus 10. When the plurality of ultrasonic transducers 21 oscillates the ultrasonic beam is transmitted toward the transmission direction (Z-axis direction) perpendicular to the transmission plane (XY plane).

### (1-1-3) Configuration of the Acoustic Wave Receiver

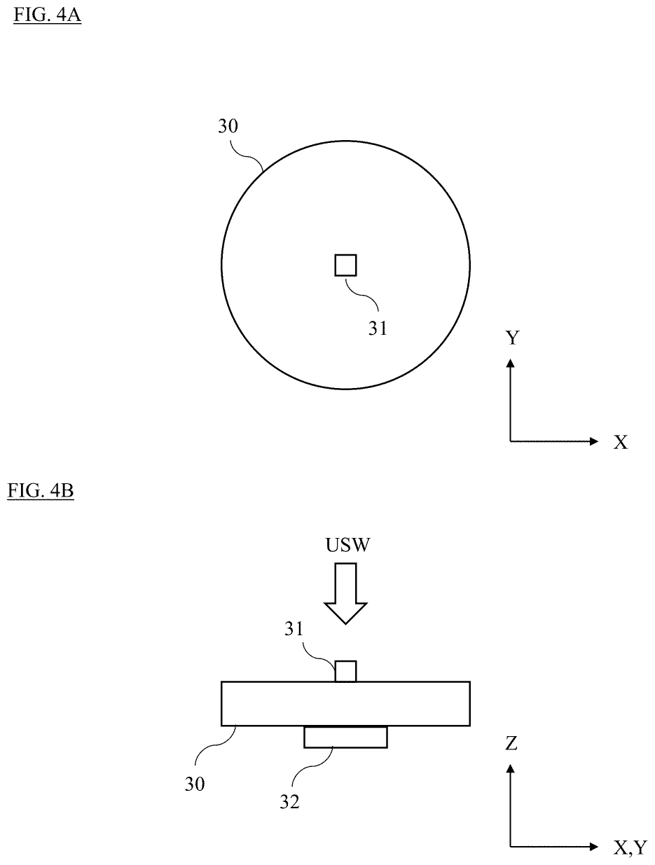

The configuration of the acoustic wave receiver 30 of the first embodiment will be described. FIGS. 4A and 4B are schematic diagrams showing a configuration of the acoustic wave receiver according to the first embodiment.

As shown in FIGS. 4A and 4B, the acoustic wave receiver 30 includes an ultrasonic transducer 31, and a control circuit 32.

The ultrasonic transducer 31 oscillates upon receiving the ultrasonic beam transmitted from the acoustic wave transmitter 20.

The control circuit 32 is configured to generate received waveform data corresponding to the oscillation of the ultrasonic transducer 31.

### (1-2) Summary of the Embodiments

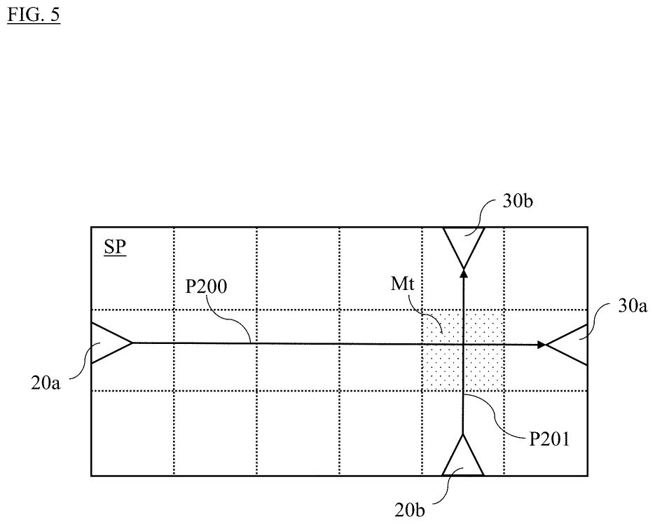

An outline of the first embodiment will be described. FIG. 5 is an explanatory diagram of the outline of the first embodiment.

As shown in FIG. 5, a temperature measuring apparatus 10 (not shown), acoustic wave transmitters 20a to 20b, and acoustic wave receivers 30a to 30b are disposed in a space (hereinafter, referred to as “target space”) SP that is a target of temperature measurement. The temperature measuring apparatus 10 can be connected to the acoustic wave transmitter 20 and the acoustic wave receiver 30.

The temperature measuring apparatus 10 controls the acoustic wave transmitters 20a-20b so as to cause the acoustic wave to be transmitted.

The temperature measuring apparatus 10 acquires received waveform data relating to the waveforms of the received acoustic waves from the acoustic wave receivers 30a to 30b.

The temperature measuring apparatus 10 calculates the temperature distribution of the target space SP based on the received waveform data.

According to the present embodiment, the temperature distribution of the target space SP is calculated from the propagation time of the acoustic wave. Thus, it is possible to improve the S/N ratio of the measurement result of the temperature of the space.

### (1-3) Data Table

The data tables of the first embodiment will be described.

### (1-3-1) Spatial Data Table

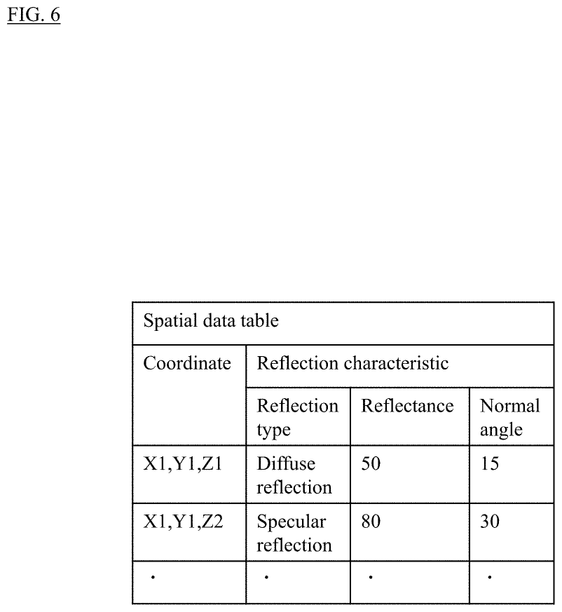

The spatial data table of the first embodiment will be described. FIG. 6 is a diagram showing a data structure of the spatial data table according to the first embodiment.

The spatial data table of FIG. 6 stores spatial information relating to a space in which the acoustic wave transmitter 20 and the acoustic wave receiver 30 are arranged (hereinafter referred to as “target space”).

The spatial data table includes a “coordinate” field and a “reflection characteristic” field. Each field is associated with one another.

The coordinates of the reflection member existing in the target space (hereinafter referred to as “reflection member coordinates”) are stored in the “coordinates” field. The reflection member coordinates are represented by a coordinate system (hereinafter referred to as a “spatial coordinate system”) having an arbitrary reference point in the target space as an origin.

The “reflection characteristic” field stores reflection characteristic information related to the reflection characteristic of the reflection member. The “Reflection characteristics” field includes a “Reflection type” field, a “Reflectance” field, and a “Normal angle” field.

Information on the reflection type is stored in the “Reflection type” field. The reflection type is one of the following:

Diffuse reflection; and

Specular reflection.

The “Reflectance” field stores the value of the reflectance of the reflective member.

The value of the normal angle of the reflection surface of the reflection member is stored in the “Normal angle” field.

### (1-3-2) Sensor Data Table

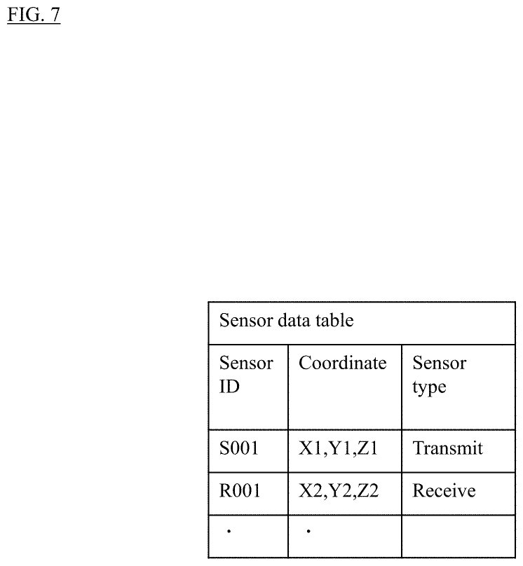

The sensor data table of the first embodiment will be described. FIG. 7 is a diagram showing a data structure of the sensor data table according to the first embodiment.

As shown in FIG. 7, the sensor data table stores information relating to the acoustic wave transmitter 20 and the acoustic wave receiver 30 (hereinafter referred to as “sensor information”).

The sensor data table includes a “sensor ID” field, a “Coordinate” field, and a “Sensor type” field.

Each field is associated with one another.

The “Sensor ID” field stores sensor identification information for identifying the acoustic wave transmitter 20 or the acoustic wave receiver 30.

In the “Coordinate” field, coordinates indicating the position of the acoustic wave transmitter 20 or the acoustic wave receiver 30 (hereinafter referred to as “sensor coordinates”) are stored. The sensor coordinates are represented in a spatial coordinate system.

The “Sensor type” field stores a tag “Transmit” indicating the acoustic wave transmitter 20, or a tag “Receive” indicating the acoustic wave receiver 30.

### (1-3-3) Path Data Table

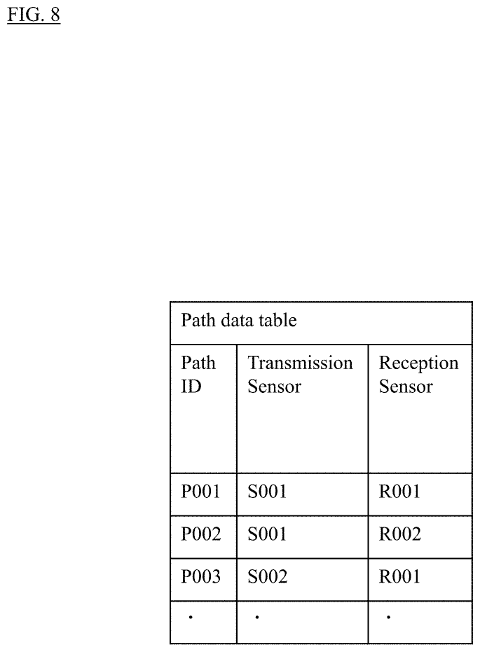

The path data table of the first embodiment will be described. FIG. 8 is a diagram showing the data structure of the path data table according to the first embodiment.

As shown in FIG. 8, the path data table stores the path information related to the path. The path data table includes a “Path ID” field, a “Transmission sensor” field, and a “Reception sensor” field.

The “Path ID” field stores the path identification information that identifies the path.

The “Transmission sensor” field stores sensor identification information of the acoustic wave transmitter 20 constituting the path.

The “Reception sensor” field stores sensor identification information of the acoustic wave receiver 30 constituting the path.

### (1-3-4) Mesh Data Table

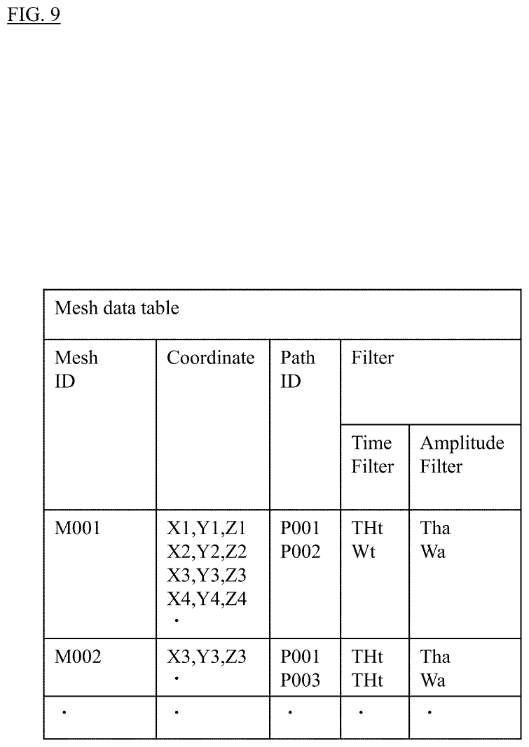

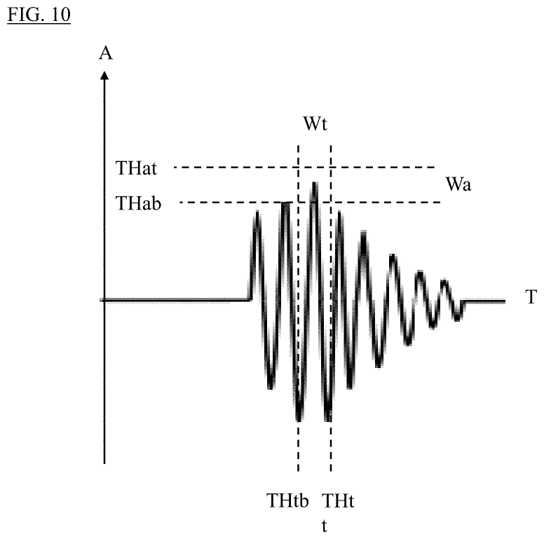

The mesh data table of the first embodiment will be described. FIG. 9 is a diagram showing a data structure of the mesh data table according to the first embodiment. FIG. 10 is an explanatory diagram of the filter of the first embodiment.

As shown in FIG. 9, mesh information about the virtual mesh is stored in the mesh data table.

The mesh data table includes a “Mesh ID” field, a “Coordinate” field, a “Path ID” field, and a “Filter” field.

The “Mesh ID” field contains mesh identification information identifying the virtual mesh.

The “Coordinate” field contains mesh coordinates indicating the position of the virtual mesh. The mesh coordinates are represented by the spatial coordinate system.

The path identification information of the path is stored in the “Path ID” field.

As shown in FIG. 10, the target space SP is divided into a plurality of virtual meshes “Mi” (“i” is an argument). Each virtual mesh Mi has a three-dimensional shape.

For example, the virtual mesh M1 includes a plurality of paths P101 and P200. Path P101 is a path from the acoustic wave transmitter 20a to the acoustic wave receiver 30a. The path P200 is a path from the acoustic wave transmitter 20b to the acoustic wave receiver 30b.

The “Filter” field stores filter information related to a filter for extracting a specific waveform from the waveform of the ultrasonic beam reproduced by the received waveform data received by the acoustic wave receiver 30. The filter information is associated with the path identification information stored in the “Path ID” field. The “Filter” field includes a “Time Filter” field and an “Amplitude Filter” field.

The “Time filter” field stores information on a time filter for extracting a specific waveform along the time axis. The time filter is, for example, at least one of the following (FIG. 10):

Lower limit time threshold “THtb”;

Upper limit time threshold “THtt”; and

Time window “Wt” defined by the lower limit time threshold “THtb” and the upper limit time threshold “THtt”.

The “Amplitude filter” field stores information on an amplitude filter for extracting a specific waveform along the amplitude axis. The amplitude filter is, for example, at least one of the following (see FIG. 10):

Lower limit amplitude threshold “THab”;

Upper limit amplitude threshold “THat”; and

Amplitude window “Wa” defined by the lower limit amplitude threshold “THab” and the upper limit amplitude threshold That.

### (1-4) Processing of Temperature Measurement

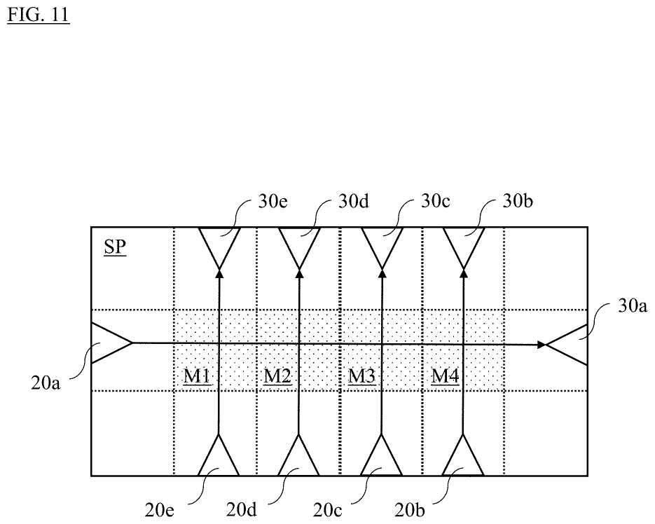

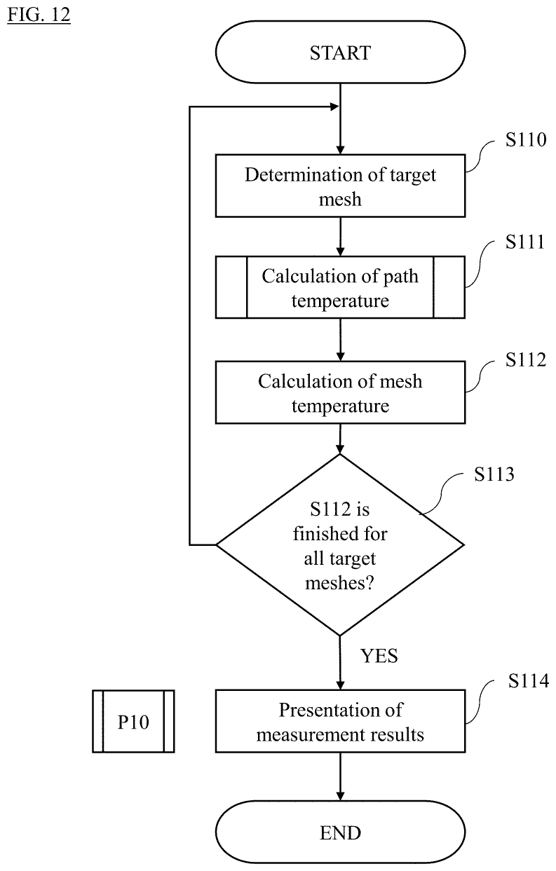

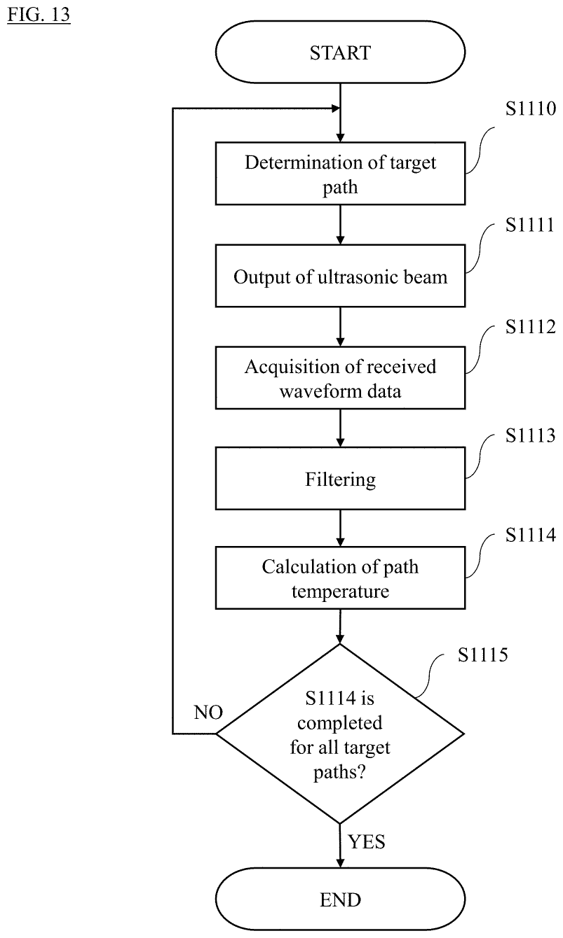

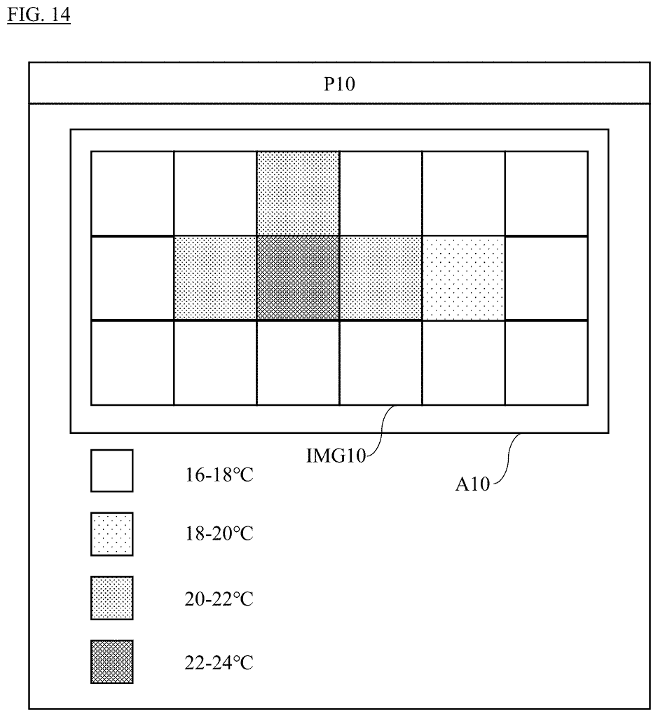

The temperature measurement process of the first embodiment will be described. FIG. 11 is a diagram showing an example of a sensor arrangement according to the first embodiment. FIG. 12 is a flowchart of the temperature measurement process according to the first embodiment. FIG. 13 is a detailed flowchart of the calculation of the path temperature of FIG. 12. FIG. 14 is a diagram showing an example of a screen displayed in the process of FIG. 12.

As shown in FIG. 11, a plurality of acoustic wave transmitters 20a to 20e and a plurality of acoustic wave receivers 30a to 30e are disposed in the target space SP.

Each of the plurality of acoustic wave transmitters 20a-20e is opposed to a plurality of acoustic wave receivers 30a-30e. For example, the acoustic wave transmitter 20a is opposed to the acoustic wave receiver 30a. This means that the acoustic wave transmitter 20a and the acoustic wave receiver 30a form a sensor pair.

FIG. 11 shows an example in which five sensor pairs are formed.

The mesh temperature of a virtual mesh including multiple paths can be measured.

FIG. 11 shows an example in which the mesh temperature of the virtual meshes M1 to M4 can be measured.

As shown in FIG. 12, the temperature measuring apparatus 10 executes the determination of target mesh (S110).

More specifically, as shown in FIG. 5, the processor 12 determines the mesh identification information of the target mesh Mt (t=1 to 4) from among a plurality of virtual meshes constituting the target space SP.

After the step S110, the temperature measuring apparatus 10 performs the calculation of path temperature (S111) according to a predetermined path temperature calculation model.

Referring to FIG. 13, step S111 will be described in detail.

The temperature measuring apparatus 10 executes the determination of target path (S1110).

Specifically, the processor 12 refers to the mesh data table (FIG. 9) and identifies the information of the “Path ID” field associated with the mesh identification information determined in the step S110 (that is, the path through the target mesh Mt (hereinafter, referred to as “target path”) “Pi” (“i” is an argument of the path)).

After the step S1110, the temperature measuring apparatus 10 performs the output of ultrasonic beam (S1111).

More specifically, the processor 12 refers to the path data table (FIG. 8) and identifies information of the “Transmission sensor” field (i.e., the acoustic wave transmitter to be controlled (hereinafter referred to as the “target acoustic wave transmitter”) 20) and information of the “Reception sensor” field (i.e., the acoustic wave receiver to be controlled (hereinafter referred to as the “target acoustic wave receiver”) 30) associated with the path identification information identified in the step S1110.

The processor 12 transmits an ultrasonic control signal to the target acoustic wave transmitter 20.

The target acoustic wave transmitter 20 transmits an ultrasonic beam in response to the ultrasonic control signal transmitted from the temperature measuring apparatus 10.

Specifically, the plurality of ultrasonic transducers 21 oscillate simultaneously in response to the ultrasonic control signal.

Thus, an ultrasonic beam traveling in the transmission direction (Z-axis direction) is transmitted toward the target acoustic wave receiver 30 from the target acoustic wave transmitter 20.

After the step S1111, the temperature measuring apparatus 10 executes the acquisition of received waveform data (S1112).

Specifically, the ultrasonic transducer 31 of the target acoustic wave receiver 30 oscillates by receiving the ultrasonic beam transmitted from the target acoustic wave transmitter 20 in the step S1111.

The control circuit 32 generates received waveform data (FIG. 10) corresponding to the oscillation of the ultrasonic transducer 31.

Control circuit 32 transmits the generated received waveform data to the temperature measuring apparatus 10.

The processor 12 of the temperature measuring apparatus 10 acquires the received waveform data transmitted from the acoustic wave receiver 30.

After the step S1112, the temperature measuring apparatus 10 performs filtering (S1113).

Specifically, the processor 12 identifies the “Filter” field associated with the path identification information of the target path Pi determined in the step S110 by referring to the mesh data table (FIG. 9).

For example, when the mesh identification information of the target mesh is “M001”, the following filter information is identified:

Path identification information “P001”: Time threshold THt1 or more and Amplitude threshold THa1 or more;

Path identification information “P002”: not less than time-threshold THt2 and within amplitude-window Wa2;

Path identification information “P003”: within the time-window Wt3 and above the amplitude-threshold THa3; and

Path identifier “P004”: in the time-window Wt4 and in the amplitude-window Wa4.

Based on the identified filter information, the processor 12 extracts a component of the ultrasonic beam traveling along the target path Pi from the components included in the received waveform data.

After the step S1113, the temperature measuring apparatus 10 executes the calculation of path temperature (S1114).

Specifically, the processor 12 refers to the “Coordinate” field of the sensor data table (FIG. 7) to identify, for each sensor pair, the coordinates of the acoustic wave transmitter 20 and the coordinates of the acoustic wave receiver 30 constituting the sensor pair.

The processor 12 calculates the distance Ds between the acoustic wave transmitter 20 and the acoustic wave receiver 30 (hereinafter, referred to as the “inter-sensor distance”) based on the identified combination of the coordinates of the acoustic wave transmitter 20 and the coordinates of the acoustic wave receiver 30.

The processor 12 identifies a time t corresponding to the peak of the components extracted in the step S1113. The propagation time t means the time from when the acoustic wave transmitter 20 transmits the ultrasonic beam until the ultrasonic beam traveling along the target path Pi reaches the acoustic wave receiver 30 (i.e., the time at which the ultrasonic beam propagates from the start point to the end point of the target path).

The processor 12 calculates the path temperature “TEMPpath i” of the target path Pi using the sound speed C of ultrasonic wave, the sensor-to-sensor distance Ds, the propagation time t, and the reference temperature T0.

If the step S1114 for all the target paths Pi has not been completed (S1115—NO), the temperature measuring apparatus 10 executes the step S1110.

When the step S1114 for all the target paths Pi is completed (S1115—YES), the temperature measuring apparatus 10 executes the calculation of mesh temperature (S112) of FIG. 12.

Specifically, the processor 12 calculates the mesh temperature “TEMPmesh t” of the target mesh Mt using the path temperature “TEMPpath i” of all the target paths Pi calculated in the step S1114 (FIG. 11) (equation 1).

TEMPmesh t=AVE(TEMPpath i) (Equation 1)

AVE(x): Function for deriving the average value of x

If the step S112 for all the target mesh Mt has not been completed (S113—NO), the temperature measuring apparatus 10 executes the step S110.

When step S112 has been completed for all the target meshes Mt (S113—YES), the temperature measuring apparatus 10 executes the presentation of measurement results (S114).

Specifically, the processor 12 displays the screen P10 (FIG. 14) on the display.

Screen P10 includes a display object A10.

An image IMG10 is displayed on the display object A10.

The image IMG10 indicates the mesh temperature TEMPmesh t calculated in the step S112 for each of the plurality of virtual meshes constituting the target space SP.

According to the first embodiment, the temperature distribution of the target space SP is calculated from the propagation time of the ultrasonic beam. Thus, it is possible to improve the S/N ratio of the measurement result of the temperature of the space.

### (2) Second Embodiment

The second embodiment will be explained. The second embodiment is an example in which the transmission direction of the ultrasonic beam of the acoustic wave transmitter 20 is variable.

### (2-1) Configuration of the Acoustic Wave Transmitter

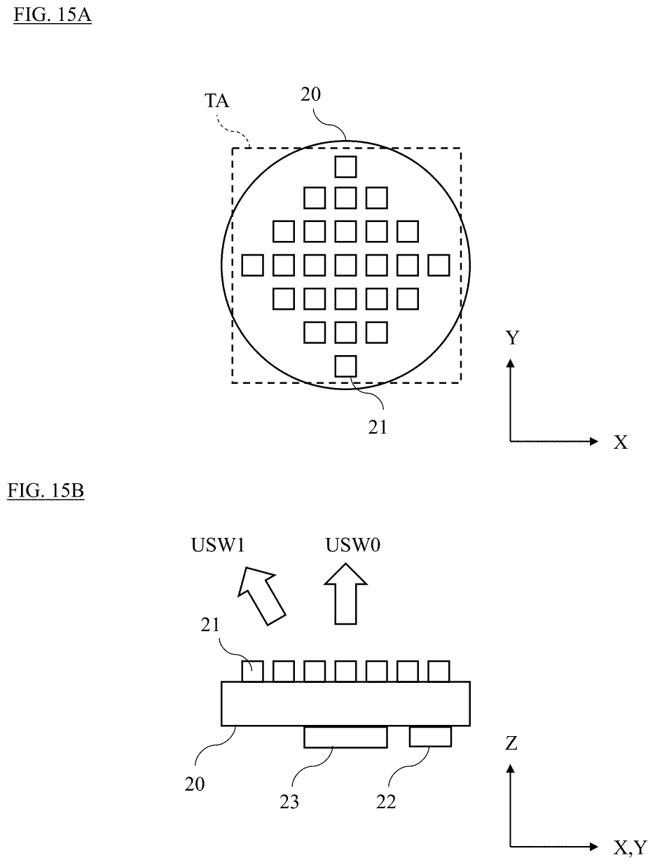

The configuration of the acoustic wave transmitter 20 will be described. FIGS. 15A and 15B are schematic diagrams showing the configuration of the acoustic wave transmitter of the second embodiment.

As shown in FIGS. 15A and 15B, the acoustic wave transmitter 20 includes a plurality of ultrasonic transducers 21, a control circuit 22, and an actuator 23.

As shown in FIG. 15A, a plurality of ultrasonic transducers 21 are two-dimensionally arranged on a transmitting plane (XY plane). That is, a plurality of ultrasonic transducers 21 form a transducer array TA.

The actuator 23 is configured to change the orientation of the transmission plane (XY plane) with respect to the transmission axis (Z-axis).

When the actuator 23 directs the transmitting surface toward the transmitting axis (Z-axis), an ultrasonic beam USW0 is transmitted.

When the actuator 23 tilts the transmitting surface with respect to the transmitting axis (Z-axis), an ultrasonic beam USW1 is transmitted.

### (2-2) Path Data Table

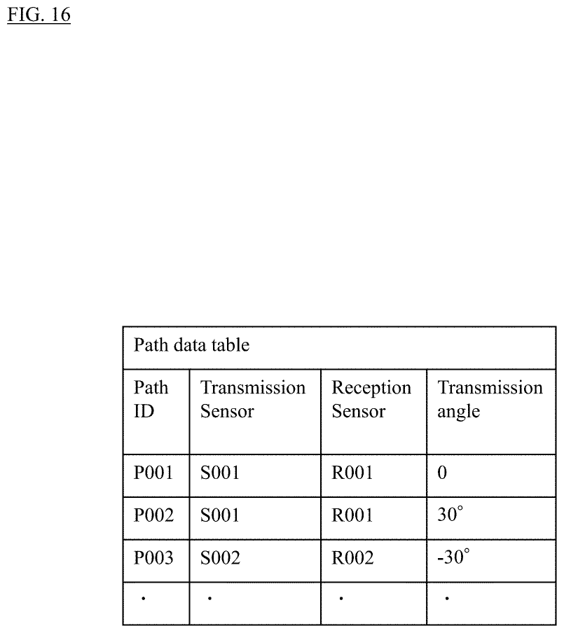

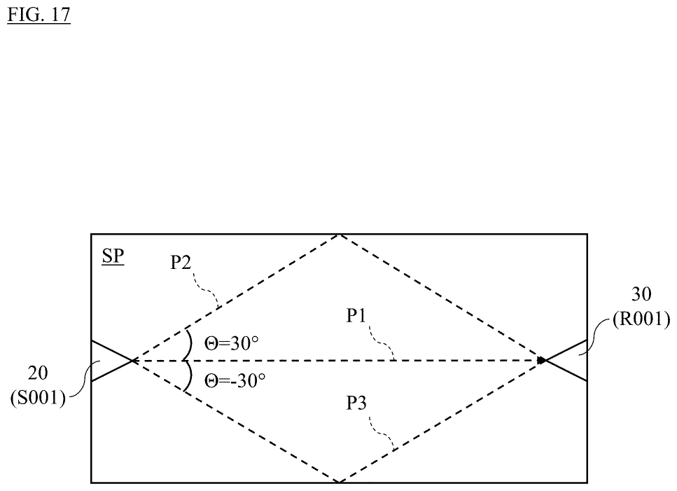

The path data table of the second embodiment will be described. FIG. 16 is a diagram showing the data structure of the path data table according to the second embodiment. FIG. 17 is an explanatory diagram of a transmission angle according to the second embodiment.

As shown in FIG. 16, the path data table includes a “Transmission angle” field in addition to the fields of FIG. 8 (a “path ID” field, a “Transmission sensor” field, and a “Reception sensor” field).

The “Transmission angle” field stores the value of the transmission angle of the ultrasonic beam with respect to the transmission axis (Z axis) of the acoustic wave transmitter 20.

As shown in FIG. 17, paths P1-P3 are identified by a combination of an acoustic wave transmitter 20, an acoustic wave receiver 30, and a transmission angle 0.

### (2-3) Information Processing

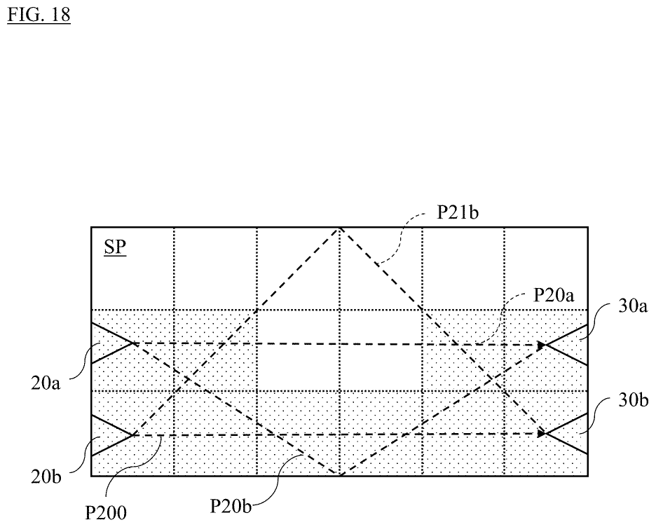

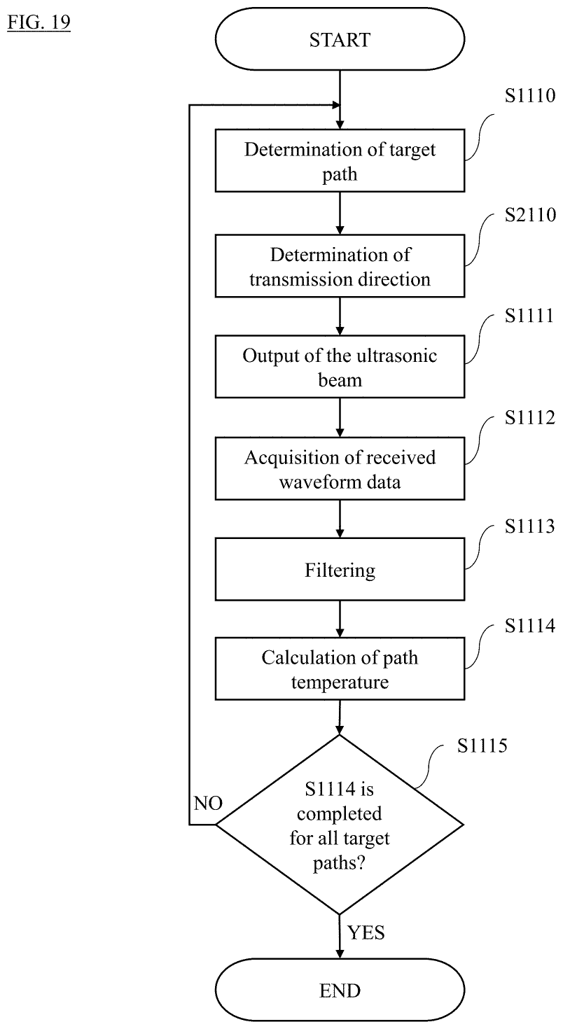

The information processing of the second embodiment will be described. FIG. 18 is a diagram showing an example of a sensor arrangement according to the second embodiment. FIG. 19 is a detailed flowchart of the calculation of the path temperature according to the second embodiment.

As shown in FIG. 18, a plurality of acoustic wave transmitters 20a-20b and a plurality of acoustic wave receivers 30a-30b are disposed in the target space SP.

Each of the plurality of acoustic wave transmitters 20a-20b is capable of transmitting an ultrasonic beam along a path reaching the plurality of acoustic wave receivers 30a-30b. For example, the acoustic wave transmitter 20a is capable of transmitting an ultrasonic beam along a path P20a reaching the acoustic wave receiver 30a and an ultrasonic beam along a path P21a reaching the acoustic wave receiver 30b.

Mesh temperature measurement of virtual mesh including the path of ultrasonic beam is possible.

Since the reflective member of the target space SP (e.g., at least one of a wall and a ceiling) includes a path P20b and P21b reflected by the ultrasonic beam, more mesh temperatures of virtual mesh can be measured.

As shown in FIG. 19, the temperature measuring apparatus 10 according to the second embodiment performs S2110 after step S1110.

Specifically, the processor 12 refers to the path data table (FIG. 8) and identifies information of the “Transmission sensor” field (i.e., the acoustic wave transmitter to be controlled (hereinafter referred to as the “target acoustic wave transmitter”) 20), information of the “Reception sensor” field (i.e., the acoustic wave receiver to be controlled (hereinafter referred to as the “target acoustic wave receiver”) 30), and information of the “Transmission angle” field (i.e., the transmission angle value of the target acoustic wave transmitter 20) associated with the path identification information identified in the step S1110.

The processor 12 transmits an ultrasonic control signal to the target acoustic wave transmitter 20. The ultrasonic control signal includes the value of the transmission angle.

The target acoustic wave transmitter 20 transmits an ultrasonic beam in a direction indicated by the value of the transmission angle included in the ultrasonic control signal transmitted from the temperature measuring apparatus 10.

Specifically, the actuator 23 refers to the value of the transmission angle included in the ultrasonic control signal to change the direction of the transmission plane (XY plane) with respect to the transmission axis (Z-axis).

The control circuit 22 simultaneously oscillates the plurality of ultrasonic transducers 21.

Thus, the ultrasonic beam traveling in the direction indicated by the value of the transmission angle included in the ultrasonic control signal is transmitted.

After the step S2110, the temperature measuring apparatus 10, similarly to FIG. 12, executes the steps S1111˜S1116.

According to the second embodiment, the transmission angle of the acoustic wave transmitter 20 is variable. This increases paths of the ultrasonic beam transmitted from one acoustic wave transmitter 20. As a result, it is possible to reduce the number of acoustic wave transmitter 20 necessary for measuring the temperature distribution of the target space SP, and it is possible to improve the degree of freedom in the arrangement of the acoustic wave transmitter 20 and the acoustic wave receiver 30.

### (3) Modifications

Modifications of the present embodiment will be described.

### (3-1) Modification 1

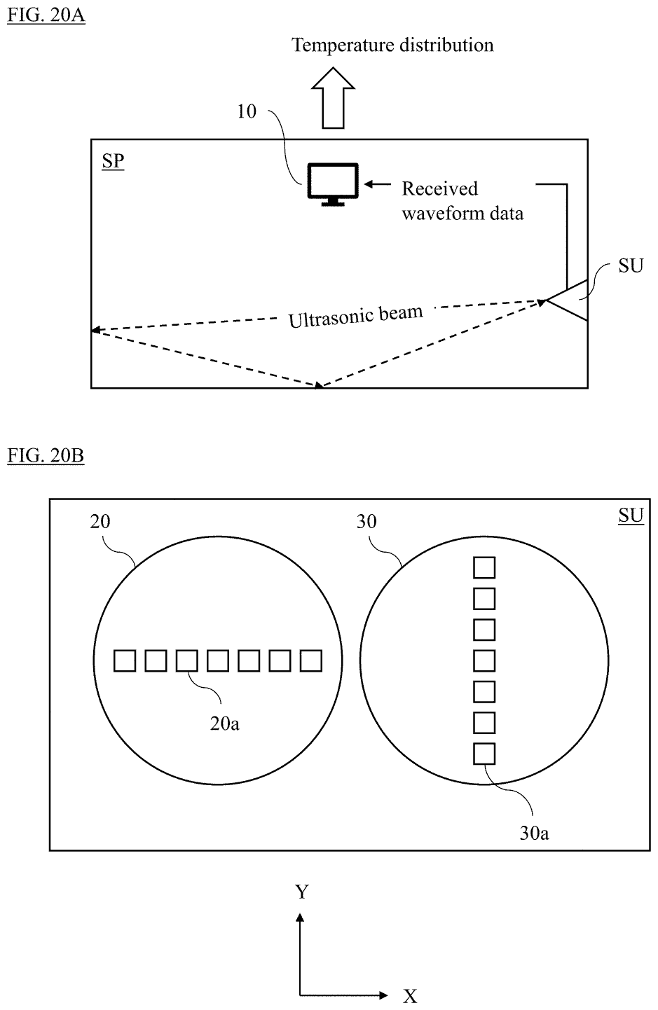

Modification 1 will be described. Modification 1 is a modification relating to the acoustic wave transmitter 20 and the acoustic wave receiver 30. FIGS. 20A and 20B are schematic diagrams showing the configuration of the acoustic wave transmitter and the acoustic wave receiver of Modification 1.

As shown in FIGS. 20A and 20B, the target space SP of Modification 1, the sensor unit SU is disposed.

The sensor unit SU includes an acoustic wave transmitter 20 and an acoustic wave receiver 30.

The acoustic wave transmitter 20 includes a plurality of ultrasonic transducers 21.

A plurality of ultrasonic transducers 21 are arranged in a constant direction (X direction).

The acoustic wave receiver 30 includes a plurality of ultrasonic transducers 31.

A plurality of ultrasonic transducers 31 are arranged in a constant direction (Y direction).

The arrangement direction of the ultrasonic transducer 21 of the acoustic wave transmitter 20 and the arrangement direction of the ultrasonic transducer 31 of the acoustic wave receiver 30 are different from each other. Preferably, the arrangement direction of the ultrasonic transducer 21 (X direction) is perpendicular to the arrangement direction of the ultrasonic transducer 31 (Y direction).

The sound pressure distribution of the ultrasonic beam transmitted from the acoustic wave transmitter 20 extends in a direction (Y direction) perpendicular to the arrangement direction (X direction) of the ultrasonic transducer 21.

This ultrasonic beam is reflected by the reflecting member of the target space SP.

The acoustic wave receiver 30 receives the ultrasonic beam reflected by the reflecting member. Sensitivity distribution of the ultrasonic transducer 31 to the ultrasonic wave of the ultrasonic transducer 31 is spread in a direction (X direction) perpendicular to the arrangement direction of the ultrasonic transducer 31 (Y direction).

According to the modification 1, the ultrasonic beam having the sound pressure distribution spreading in the Y direction, the waveform data corresponding to the oscillation of the ultrasonic transducer 31 having the sensitivity distribution spreading in the X direction is obtained. That is, the acoustic wave receiver 30 obtains the strongest component of the point where the sound pressure distribution and the sensitivity distribution intersect. Thus, it is possible to increase the resolution of the measurement of the spatial temperature.

### (3-2) Modification 2

Modification 2 will be described. Modification 2 is an example of changing the transmission direction without using the actuator 23.

Control circuit 22 of Modification 2 calculates the phase difference required to realize the transmission angle with respect to the Z-axis according to the value of the transmission angle included in the ultrasonic control signal.

The control circuit 22 oscillates the plurality of ultrasonic transducers 21 at different timings such that the ultrasonic beams occur the calculated phase difference. The difference in the timing of the oscillations of each ultrasonic transducer 21 forms the phase difference of the ultrasonic waves transmitted from each ultrasonic transducer 21.

Thus, the ultrasonic beam traveling in the direction indicated by the value of the transmission angle included in the ultrasonic control signal is transmitted.

According to Modification 2, it is possible to change the transmission direction without using the actuator 23 (i.e., a mechanical mechanism for changing the transmission direction).

### (3-3) Modification 3

Modification 3 will be described. Modification 3 is an example in which the filter is corrected in accordance with the temperature of the target space SP.

In the step S1113, the processor 12 of the Modification 3 acquires the reference temperature from the thermometer 50.

The processor 12 corrects the identified filter information based on the reference temperature.

Based on the corrected filter information, the processor 12 extracts a component of the ultrasonic beam traveling along the target path Pi from the components included in the received waveform data.

According to the Modification 3, filtering is performed based on the temperature of the target space SP. Thus, it is possible to more reliably extract the components of the ultrasonic beam traveling along the target path Pi from the received waveform data. As a result, the accuracy of the calculation of the mesh temperature can be improved.

### (3-4) Modification 4

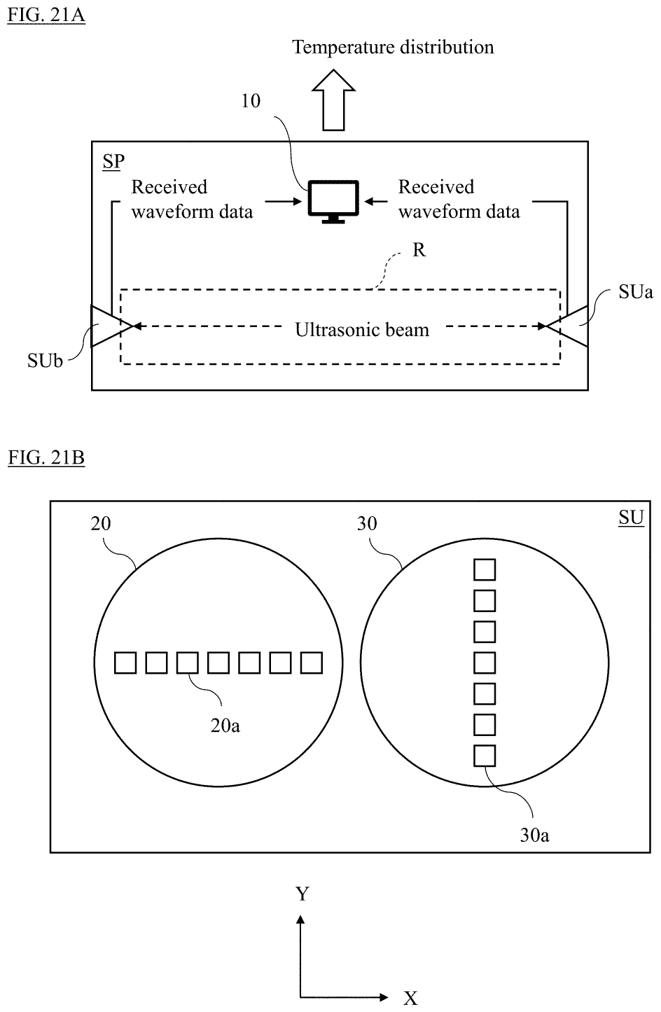

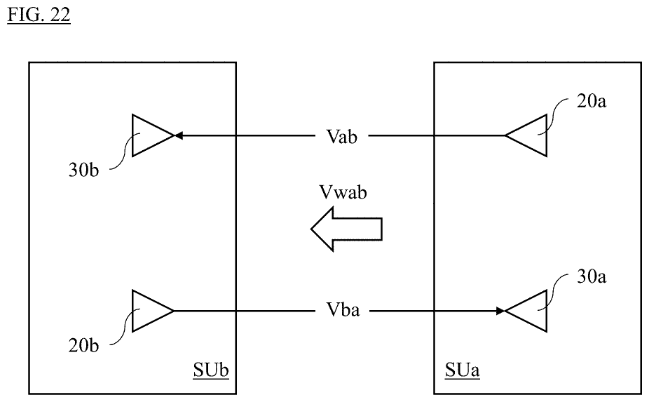

Modification 4 will be described. Modification 4 is an example of reducing the influence of the airflow in the target space SP on the measurement result. FIGS. 21A and 21B are schematic diagrams showing the configuration of the acoustic wave transmitter and the acoustic wave receiver of Modification 4. FIG. 22 is an explanatory diagram of the principle of Modification 4.

As shown in FIGS. 21A and 21B, the target space SP of Modification 4, at least two sensor units “SUa” and “Sub” are arranged (FIG. 21A).

The sensor units SUa and SUb each comprise an acoustic wave transmitter 20 and an acoustic wave receiver 30 (FIG. 21B).

The ultrasonic beam transmitted from the acoustic wave transmitter 20a of the sensor unit SUa is received by the acoustic wave receiver 30b of the sensor unit SUb.

The acoustic wave receiver 30b generates received waveform data corresponding to the received ultrasonic beam (an example of “the second received waveform data”).

The ultrasonic beam transmitted from the acoustic wave transmitter 20b of the sensor unit SUb is received by the acoustic wave receiver 30a of the sensor unit SUa.

The acoustic wave receiver 30a generates received waveform data corresponding to the received ultrasonic beam (an example of “the first received waveform data”).

As shown in FIG. 22, with respect to the absolute value |Vab| of the actual velocity of the ultrasonic beam traveling along the path from the acoustic wave transmitter 20a to the acoustic wave receiver 30b (hereinafter referred to as the “forward path”), the relationship of Equation 2a holds.

|Vab|=Dab/tab=C+Vwab (Equation 2a)

Dab: Distance between sensors between sensor units SUa and SUb

tab: propagation time of forward path

Vwab: Wind velocity components between sensor units SUa and SUb

The path from the acoustic wave transmitter 20b to the acoustic wave receiver 30a (hereinafter referred to as the “backward path”) is the opposite direction of the forward path. Therefore, with respect to the absolute value |Vba| of the actual velocity of the ultrasonic beam traveling in the backward path, the relationship of Equation 2b holds.

|Vba|=Dab/tba=C−Vwab (Equation 2b)

tba: propagation time of backward path

The temperature measuring apparatus 10, using Equation 2c, the average speed |Va:b| of the sensor unit SUa and SUb Calculate.

|Va:b|=(|Vab|+|Vba|)/2 (Equation 2c)

Equation 2c cancels out the wind velocity component Vab of forward path and the wind velocity component Vba of backward path from each other. Therefore, the average speed |Va:b| does not include the wind velocity components Vwab.

The temperature measuring apparatus 10 refers to the data on the acoustic wave velocity characteristic stored in the storage device 11 to calculate temperature corresponding to the average speed |Va:b|.

According to Modification 4, the temperature corresponding to the average speed that does not include the wind velocity component between the pair of sensor units SUa and Sub is calculated. Thus, it is possible to further improve the S/N ratio of the measurement result of the temperature of the space.

In Modification 4, an example of using the two sensor units SUa and SUb has been described, the present embodiment is not limited thereto. For example, the present embodiment can be applied to the case where an average of three or more kinds of sound velocities or similar signals is used as long as the condition that the acoustic waves pass through substantially the same traveling path and the vector sum of the wind velocity components included in the acoustic waves to be canceled is satisfied.

In Modification 4, an example of using the two sensor units SUa and SUb has been described, the present embodiment is not limited thereto. Modification 4 is also applicable when using one or more reflection scattering paths.

### (3-5) Modification 5

Modification 5 will be described. Modification 5 is an example of a temperature measurement algorithm using a time series filter.

### (3-5-1) Outline of Modification 5

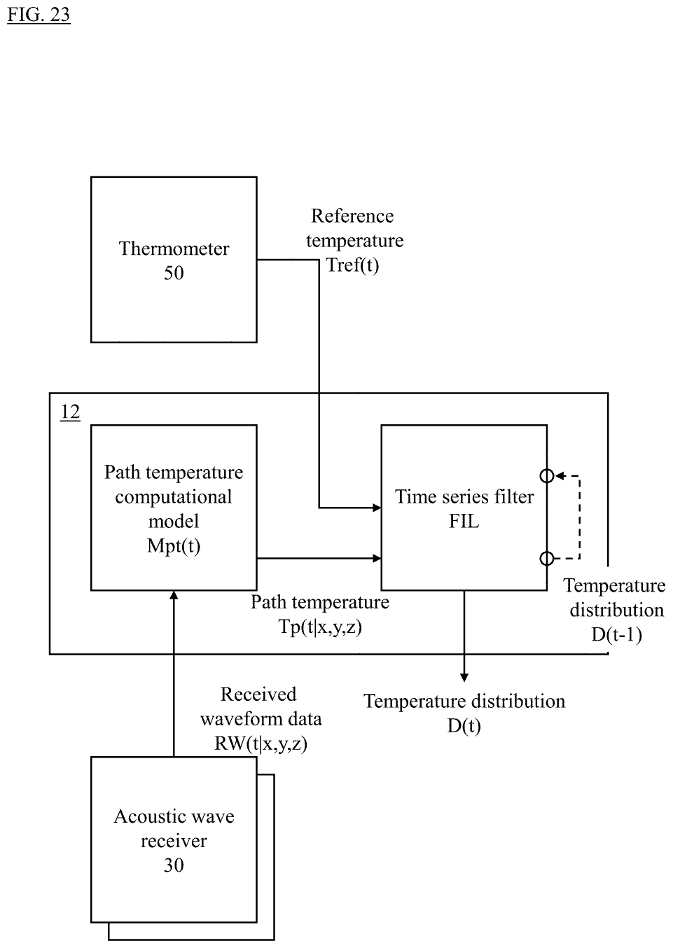

The outline of Modification 5 will be described. FIG. 23 is an explanatory diagram of an outline of Modification 5.

As shown in FIG. 23, the processor 12 of the modification 5 is configured to execute the path temperature calculation model Mpt(t) and the time-series filter FIL.

The path temperature calculation model Mpt(t) is configured to output the path temperature PD(t|x, y, z) at the time tin accordance with the reception waveform data RW(t|x, y, z) at the time t.

Time series filter FIL is configured to output a temperature distribution Dt (t) of time tin accordance with a combination of the output of the path temperature calculation model Mpt (t) (path temperature PD (t|x, y, z)), the reference temperature “Tref” of the time t measured by the thermometer 50(t), and the temperature distribution D of time t−1 (t−1).

The time-series filter FIL includes, for example, at least one of the following:

Kalman filter;

Extended Kalman filter;

Unscented Kalman filter; and

Particle filter

### (3-5-2) Processing of Temperature Measurement

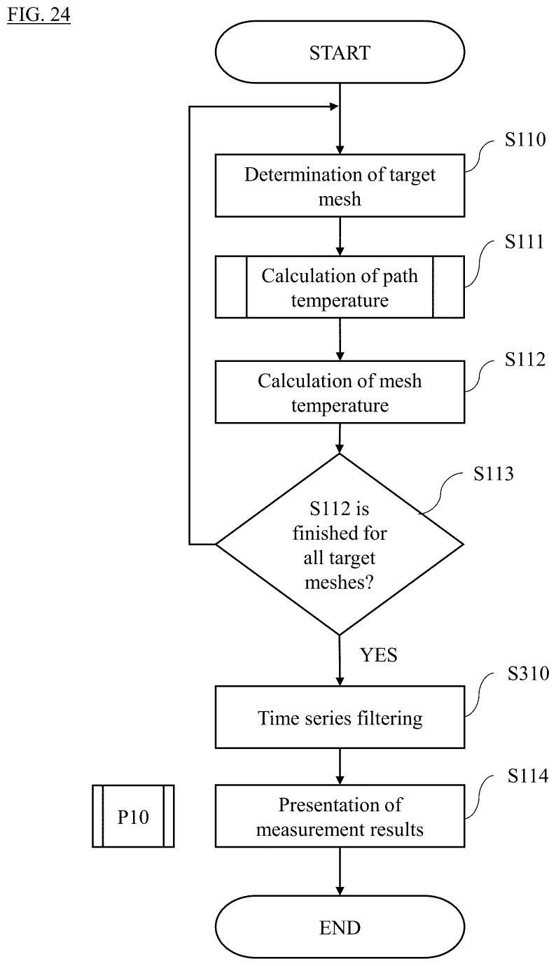

Processing of the temperature measurement of Modification 5 will be described. FIG. 24 is a flowchart of the processing of the temperature measurement of Modification 5.

As shown in FIG. 24, the temperature measuring apparatus 10 of Modification 5, as in FIG. 12, executes the steps S110˜S113.

If the step S112 for all the target mesh Mt has not been completed (S113—NO), the temperature measuring apparatus 10 executes the step S110.

When step S112 is completed for all the target meshes Mt (S113—YES), the temperature measuring apparatus 10 performs time-series filtering (S310).

Specifically, the processor 12 acquires the reference temperature Tref(t) at time t from the thermometer 50.

The processor 12 inputs the path temperature Tp(t|x, y, z) of the time t obtained in the step S111, the reference temperature Tref (t), and the temperature distribution of time t−1 (t−1) to the time series filter FIL to calculate the temperature distribution D (t) of time t.

The temperature distribution D(t) is referenced in the calculation of the temperature distribution D(t+1) at time t+1.

According to Modification 5, by performing time series filtering, it is possible to further improve the S/N ratio of the measurement result of the temperature of the space.

Incidentally, the time-series filter FIL of Modification 5, further refers to the external environment information of time t−1 to calculate the temperature distribution D (t) of time t. The external environment information at the time t−1 includes, for example, the following information:

Information about the amount of heat of the air conditioner 40;

Information about the ambient air temperature around the target space SP;

Information on the three-dimensional shape of the target space SP;

Information on the thermal insulation performance of the target space SP;

Information on the number of people present in the subject space SP;

Information about the movements of people present in the subject space SP;

Information about the wind of the air conditioner 40; and

Information on the wind in the target space SP.

### (3-6) Modification 6

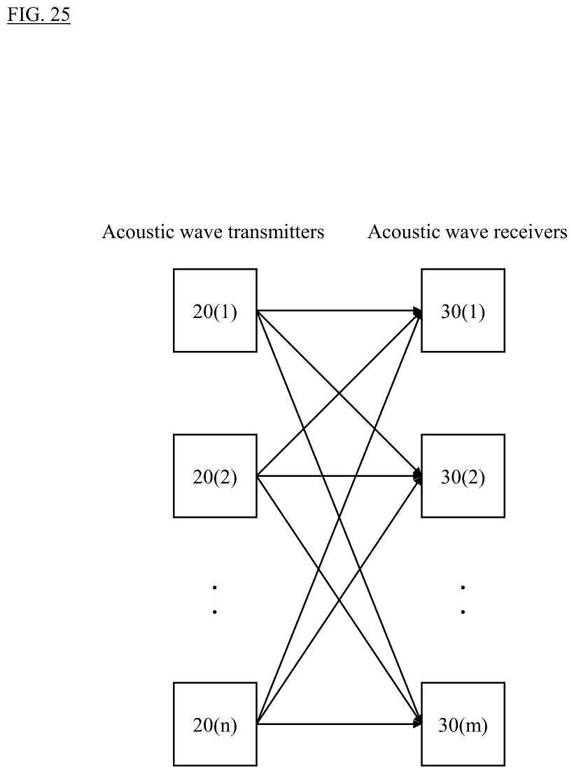

Modification 6 will be described. Modification 6 is an example of a combination of N (N is an integer of 2 or more) acoustic wave transmitters 20 and M (M is an integer of 2 or more) acoustic wave receivers 30. FIG. 25 is a schematic diagram of acoustic wave transmitters and acoustic wave receivers of Modification 6.

As shown in FIG. 25, N acoustic wave transmitters 20(1)-20(N) transmit ultrasonic beams.

M acoustic wave receivers 30(1)-30(M) receive ultrasonic beams transmitted from N acoustic wave transmitters 20(1)-20(N), respectively, and generate received waveform data corresponding to the ultrasonic beam.

The processor 12 of the first example of the Modification 6 performs the filtering (S1113) of FIG. 13 on the received waveform data generated by the acoustic wave receivers 30 (1) to 30 (M) to identify the path of the ultrasonic beam corresponding to the received waveform data (i.e., the combination of the acoustic wave transmitter 20(n) (where n is an integer of 2 to N) and the acoustic wave receiver 30(m)).

The processor 12 of the second example of the Modification 6 converts the received waveform data into an envelope, and identifies the time of the rise of the envelope. The processor 12 identifies the path of the ultrasonic beam corresponding to the received waveform data (i.e., the combination of the acoustic wave transmitter 20(n) which is the source of the ultrasonic beam and the acoustic wave receiver 30(m)) according to the identified time.

The acoustic wave transmitter 20(n) of the third example of the Modification 6 transmits an ultrasonic beam having different frequencies from each other. The processor 12 refers to the frequency of the received waveform data to identify the path of the ultrasonic beam corresponding to the received waveform data (i.e., the combination of the acoustic wave transmitter 20(n) which is the source of the ultrasonic beam) and the acoustic wave receiver 30(m).

According to a modification 6, one acoustic wave receiver 30 receives ultrasonic beams transmitted from the plurality of acoustic wave transmitter 20(n). The temperature measuring apparatus 10 identifies the acoustic wave transmitter 20(n) which oscillates the ultrasonic beam by filtering the received waveform data. Thus, it is possible to improve the S/N ratio of the measurement result of the temperature of the space.

### (3-7) Modification 7

Modification 7 will be described. Modification 7 is an example of measuring the distribution of the wind vector in addition to the temperature.

In the target space SP of Modification 7, for example, a temperature measuring apparatus 10 (not shown) of FIG. 5, at least two acoustic wave transmitters 20a to 20b, and at least two acoustic wave receivers 30a to 30b are disposed.

The temperature measuring apparatus 10 controls the acoustic wave transmitter 20a so as to transmit an ultrasonic beam having a predetermined transmission frequency Fs.

The acoustic wave transmitter 20a transmits an ultrasonic beam having a transmission frequency Fs in accordance with the control of the temperature measuring apparatus 10.

The acoustic wave receiver 30a generates received waveform data upon receiving the ultrasonic beam. The ultrasonic beam received by the acoustic wave receiver 30a has a Doppler effect caused by the wind between the acoustic wave transmitter 20a and the acoustic wave receiver 30a. Therefore, the reception frequency Fra of the ultrasonic beam received by the acoustic wave receiver 30a is different from the transmission frequency Fs.

The temperature measuring apparatus 10 acquires the received waveform data from the acoustic wave receiver 30a, and identifies the reception frequency Fra with reference to the received waveform data.

Considering the Doppler effect, the relationship of Equation 3.1 holds between the transmission frequency Fs and the reception frequency Fra.

Fs=(C+Vwa)/C×Fra (Equation 3.1)

C: Speed of sound of ultrasonic waves

Vwa: Theoretical wind velocity on the path between the acoustic wave transmitter 20a and the acoustic wave receiver 30a

By expanding Equation 3.1, the theoretical wind velocity Vwa can be expressed as shown in Equation 3.2. The processor 12 calculates the theoretical wind velocity Vwa using Equation 3.1.

Vwa=C×Fs/Fra−C (Equation 3.2)

The processor 12 calculates the theoretical wind velocity Vwb on the path between the acoustic wave transmitter 20b and the acoustic wave receiver 30b using Equation 3.3.

Vwb=C×Fs/Frb−C (Equation 3.3)

Frb: reception frequency of the ultrasonic beam received by the acoustic wave receiver 30b

The correlation function G(x) between the temperature and the wind velocity is stored in advance in the storage device 11.

The processor 12 calculates the corrected wind velocities “Vrwa” and “Vrwb” as in Equations 3.4 to 3.5 using the mesh-temperature TEMPmesh obtained in the step S112 and the correlation function.

Vrwa=G(Tmesh)×Vwa (Equation 3.4)

Vrwb=G(Tmesh)×Vwb. (Equation 3.5)

The temperature measuring apparatus 10 calculates the wind vector by synthesizing the corrected wind velocity Vrwa and Vrwb obtained from Equations 3.4 to 3.5, referring to the angle formed by the traveling path from the acoustic wave transmitter 20a to the acoustic wave receiver 30a and the traveling path from the acoustic wave transmitter 20b to the acoustic wave receiver 30b.

According to the Modification 7, the wind vector of the mesh including the intersection where the traveling paths of the ultrasonic waves intersect is obtained. Therefore, when a plurality of intersections is formed, the distribution of the wind vector of the target space SP (i.e., the distribution of wind velocity and wind direction) is obtained.

In Modification 7, an example is shown in which two traveling paths form intersections. In this case, the dimension of the resulting wind vector is two-dimensional.

The Modification 7 is also applicable to the case where three traveling paths form intersections. In this case, the dimension of the resulting wind vector is three-dimensional.

### (3-8) Modification 8

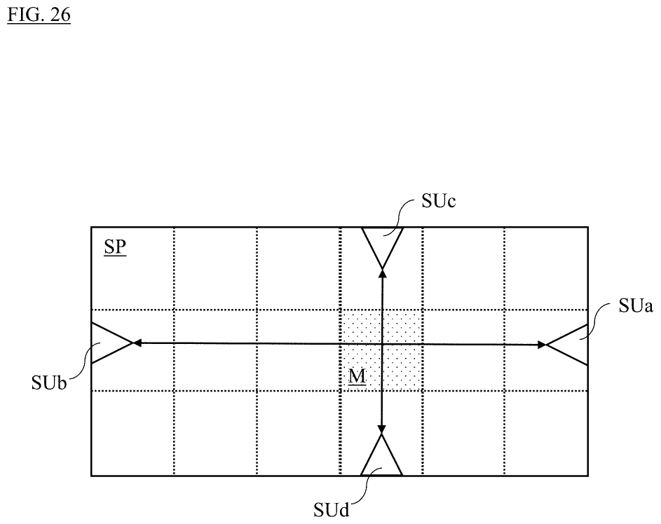

Modification 8 will be described. Modification 8 is an example of measuring the distribution of the wind vector using an ultrasonic wave. FIG. 26 is a diagram showing an example of the sensor arrangement of Modification 8.

As shown in FIG. 26, in the target space SP of the Modification 8, at least four sensor units SUa to SUd are arranged such that the traveling paths of the ultrasonic waves from the sensor units SUa to SUb and the traveling paths of the ultrasonic waves from the sensor units SUc to SUd intersect each other (preferably orthogonal).

The configuration of the sensor units SUa to SUd is the same as in Modification 4 (FIG. 21B).

The temperature measuring apparatus 10 of Modification 8 uses Equation 4.1 to calculates the wind velocity component Vwab between the sensor units SUa and SUb by removing the temperature factors from the absolute value |Vab| of the velocity of the ultrasonic beam traveling in the forward path between the sensor units SUa to SUb.

Vwab=|Vab|−|Va:b| (Equation 4.1)

The temperature measuring apparatus 10 uses Equation 4.2 to calculate the wind velocity component Vwcd between the sensor units SUc and SUd by removing the temperature factors from the absolute value |Vcd| of the velocity of the ultrasonic beam traveling in the forward path between the sensor units SUc to SUd.

Vwcd=|Vcd|−|Vc:d| (Equation 4.2)

|Vc:d|: Average speed of the sensor units SUc and SUd

Referring to the angles formed by the traveling path from the sensor units SUa to SUb and the traveling path of the sensor units SUc to SUd, the temperature measuring apparatus 10 calculates the wind vector by synthesizing the wind velocity component Vwab obtained from Equation 4.1 and the wind velocity component Vwcd obtained from Equation 4.2.

According to Modification 8, the wind vector of the mesh in which the traveling path of the ultrasonic wave of the sensor unit disposed in the target space SP includes an intersection is obtained. Therefore, when a plurality of intersections is formed, instead of the temperature distribution of the target space SP, the distribution of the wind vector (i.e., wind velocity and wind direction) is obtained.

In Modification 8, instead of the absolute values |Vab| and |Vcd| of the ultrasonic beam traveling in the forward path, the absolute values |Vba| and |Vdc| of the ultrasonic beam traveling in the backward path may be used to estimate the wind vector.

In Modification 8, an example in which a pair of sensor units forms an intersection is shown. In this case, the dimension of the resulting wind vector is two-dimensional.

Incidentally, Modification 8 is also applicable when the three sensor units form an intersection. In this case, the dimension of the resulting wind vector is three-dimensional.

### (3-9) Modification 9

Modification 9 will be described. Modification 9 is an example of measuring the temperature using the transducer array.

### (3-9-1) Configuration of the Measurement system of Modification 9

The configuration of the measurement system 1 of the Modification 9 will be described.

### (3-9-1-1) Configuration of the Acoustic Wave Transmitter of Modification 9

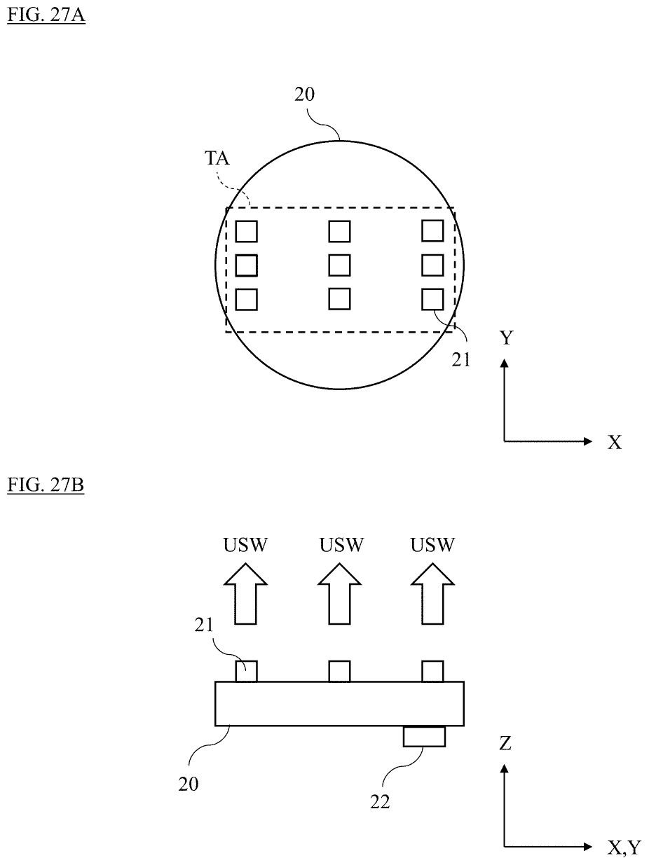

The configuration of the acoustic wave transmitter 20 of the Modification 9 will be described. FIGS. 27A and 27B are diagrams showing a configuration of an acoustic wave transmitter of Modification 9.

As shown in FIGS. 27A and 27B, the acoustic wave transmitter 20 includes a plurality of ultrasonic transducers 21 and a control circuit 22.

As shown in FIG. 27A, a plurality of ultrasonic transducers 21 are two-dimensionally arranged on a transmitting plane (XY plane). That is, a plurality of ultrasonic transducers 21 form a transducer array TA.

As shown in FIG. 27B, each ultrasonic transducer 21 transmits an ultrasonic beam USW traveling along the Z-direction.

### (3-9-1-2) Configuration of the Acoustic Wave Receiver of Modification 9

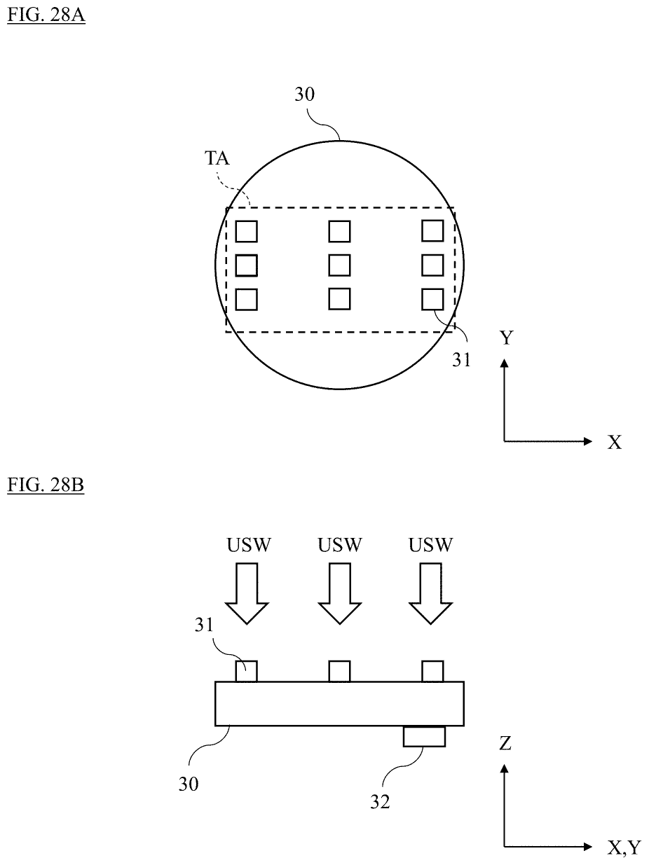

The configuration of the acoustic wave receiver 30 of the Modification 9 will be described. FIGS. 28A and 28B are diagrams showing a configuration of an acoustic wave receiver of Modification 9.

As shown in FIGS. 28A and 28B, the acoustic wave receiver 30 includes a plurality of ultrasonic transducers 31, and a control circuit 32.

As shown in FIG. 28A, a plurality of ultrasonic transducers 31 are two-dimensionally arranged on a transmitting plane (XY plane). That is, a plurality of ultrasonic transducers 31 form a transducer array TA.

As shown in FIG. 28B, the ultrasonic transducers 31 oscillate upon receiving the ultrasonic beam USW transmitted from the acoustic wave transmitter 20.

### (3-9-2) Specific Example of Modification 9

A specific example of Modification 9 will be described.

### (3-9-2-1) First Example of Modification 9

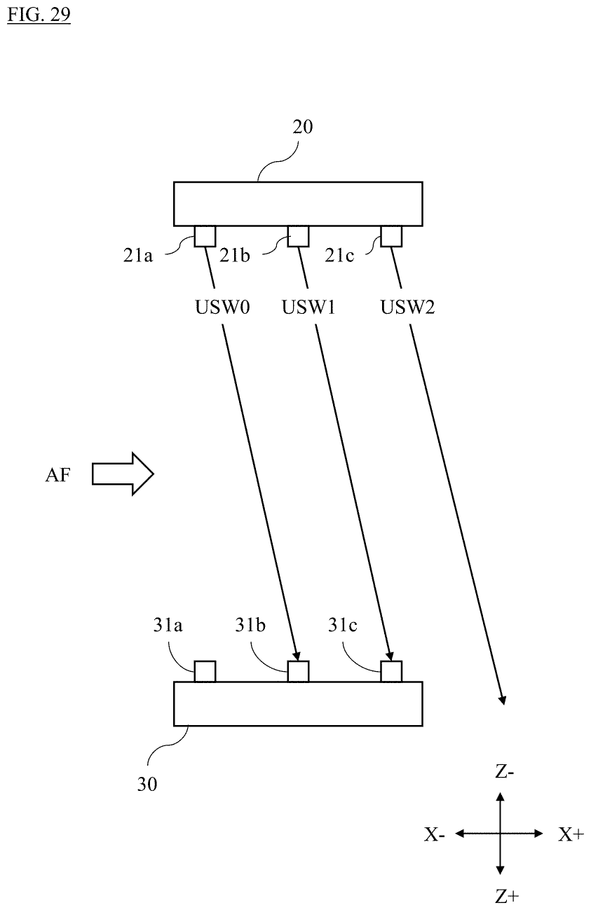

A first example of Modification 9 will be described. The first example of Modification 9 is an example of measuring the temperature using a pair of acoustic wave receiver 30 and the acoustic wave transmitter 20. FIG. 29 is a diagram showing an outline of a first example of Modification 9.

Hereinafter, in the target space SP, airflow AF toward the X+ direction of FIG. 29 is present.

The transducers 21a-21c of the acoustic wave transmitter 20 of the first embodiment of Modification 9 transmit ultrasonic beam USW0 USW2 toward the Z+ direction, respectively.

The ultrasonic beam USW0˜USW2 is shifted toward X+ due to the effect of airflow AF.

Consequently, the ultrasonic beam USW2 travels toward the exterior of the acoustic wave receiver 30.

On the other hand, the ultrasonic beam USW0˜USW1 is received by the ultrasonic transducers 31b-31c.

In this manner, both the acoustic wave transmitter 20 and the acoustic wave receiver 30 form transducer arrays TA. Thus, the ultrasonic beam USW0˜USW2 radiated from the transducer array TA of the acoustic wave transmitter 20 is easily reached the transducer array TA of the acoustic wave receiver 30 even if affected by the airflow AF. As a result, the same effect as that of the present embodiment can be obtained without being affected by the airflow AF.

### (3-9-2-2) Second Example of Modification 9

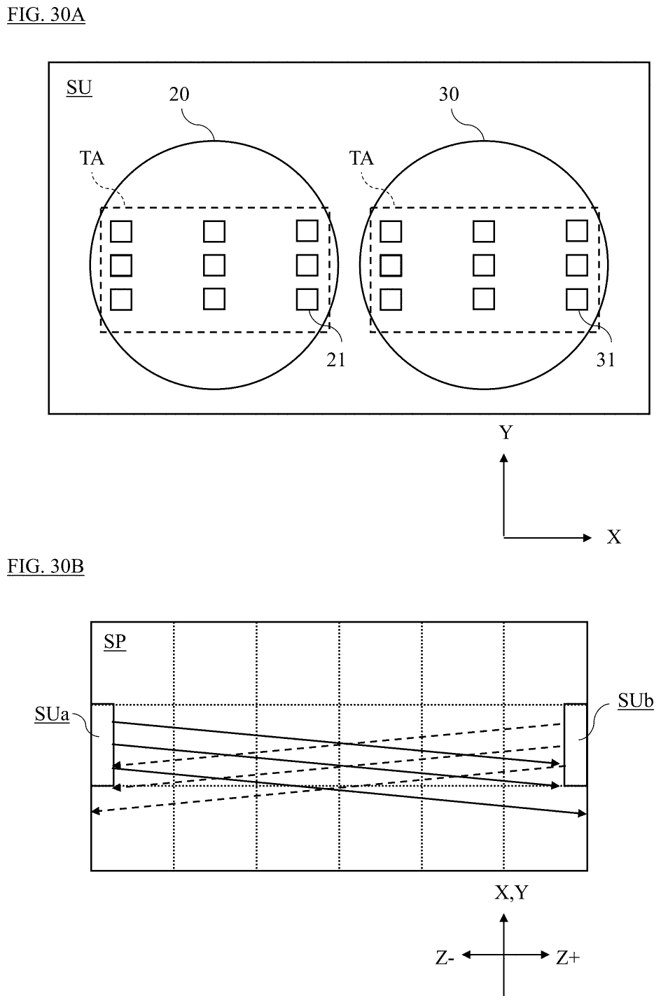

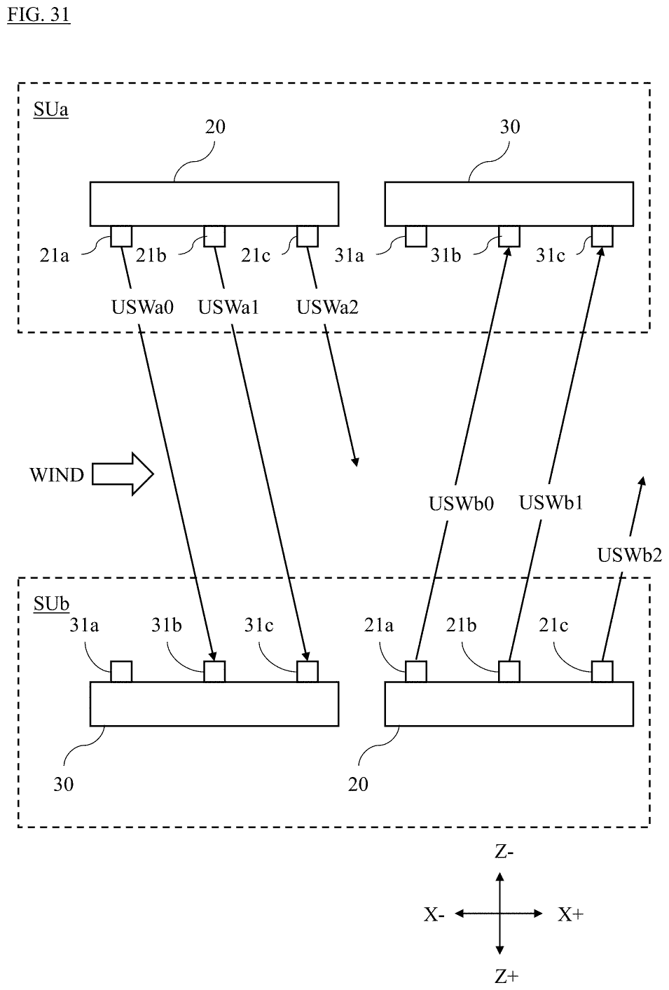

A second example of Modification 9 will be described. The second example of Modification 9 is an example of measuring the temperature using a pair of sensor units SU (combination of the acoustic wave receiver 30 and the acoustic wave transmitter 20). FIGS. 30A and 30B are diagrams showing a configuration of a sensor unit of Modification 9. FIG. 31 is a diagram showing an outline of a second example of Modification 9.

As shown in FIG. 30A, the sensor unit SU of the second example of Modification 9 includes an acoustic wave transmitter 20 and an acoustic wave receiver 30.

The acoustic wave transmitter 20 includes a plurality of ultrasonic transducers 21 and a control circuit 22.

A plurality of ultrasonic transducers 21 are two-dimensionally arranged on the transmission plane (XY plane). That is, a plurality of ultrasonic transducers 21 form a transducer array TA.

The acoustic wave receiver 30 includes a plurality of ultrasonic transducers 31, and a control circuit 32.

A plurality of ultrasonic transducers 31 are two-dimensionally arranged on the transmission plane (XY plane). That is, a plurality of ultrasonic transducers 31 form a transducer array TA.

As shown in FIG. 30B, the target space SP, a pair of sensor units SUa and SUb are arranged.

The acoustic wave transmitter 20 of the sensor unit SUa radiates ultrasonic waves toward the acoustic wave receiver 30 of the sensor unit SUb.

The acoustic wave transmitter 20 of the sensor unit SUb radiates ultrasonic waves toward the acoustic wave receiver 30 of the sensor unit SUa.

Hereinafter, in the target space SP, airflow AF toward the X+ direction of FIG. 31 is present.

The transducers 21a-21c of the acoustic wave transmitter 20 of the sensor unit SUa transmit ultrasonic beams USWa0˜USWa2 toward the Z+ direction, respectively.

The transducers 21a-21c of the acoustic wave transmitter 20 of the sensor unit SUb transmit ultrasonic beams USWb0˜USWb2 toward the Z-direction, respectively.

The ultrasonic beams USWa0˜USWa2 and USWb0˜USWb2 are shifted toward X+ due to the effect of airflow AR

Consequently, the ultrasonic beam USWa2 travels toward the exterior of the acoustic wave receiver 30 of the sensor unit SUb. The ultrasonic beam USWb2 travels toward the exterior of the acoustic wave receiver 30 of the sensor unit SUa.

On the other hand, the ultrasonic beams USWa0˜USWa1 are received by the ultrasonic transducers 31b to 31c of the acoustic wave receiver 30 of the sensor unit SUb. The ultrasonic beams USWb0˜USWb1 are received by the ultrasonic transducers 31b-31c of the acoustic wave receiver 30 of the sensor unit SUa.

In this manner, both the acoustic wave transmitter 20 and the acoustic wave receiver 30 form transducer arrays TA. Thus, the ultrasonic beams USW0˜USW2 radiated from the transducer array TA of the acoustic wave transmitter 20 are easily reached the transducer array TA of the acoustic wave receiver 30 even if affected by the airflow AF. In addition, the temperature of the space between the sensor units SUa-SUb is measured using both an ultrasonic beam traveling in the Z-direction and an ultrasonic beam traveling in the Z+ direction. As a result, the same effect as that of the present embodiment can be obtained without being affected by the airflow AR

### (3-10) Modification 10

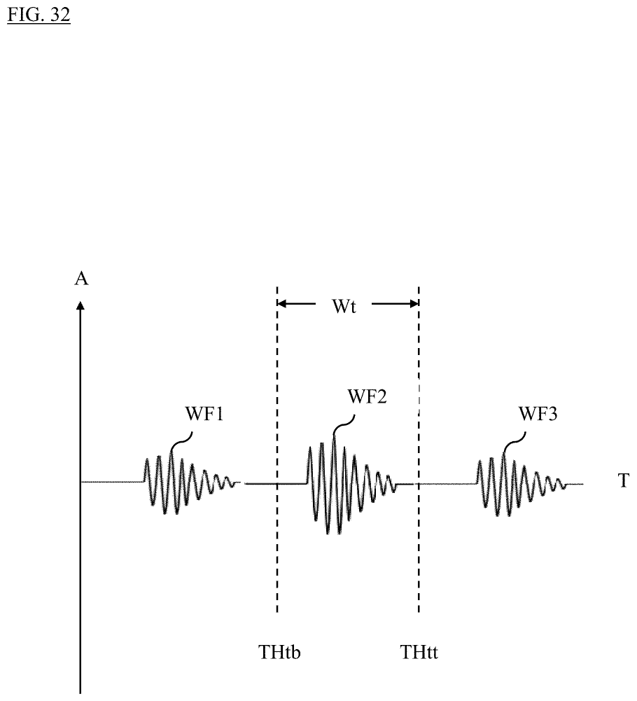

Modification 10 will be described. Modification 10 is an example for identifying the waveform to be referenced from among the waveforms of the acoustic wave received by one acoustic wave receiver 30. FIG. 32 is an explanatory diagram of a filter of Modification 10.

### (3-10-1) First Example of Modification 10

A first example of Modification 10 will be described.

The acoustic wave receiver 30 of the first example of Modification 10 has a time filter for each path. The time filter is, for example, at least one of the following (FIG. 32):

Lower limit time threshold THtb;

Upper limit time threshold THtt; and

Time window Wt defined by the lower limit time threshold THtb and the upper limit time threshold THtt

The lower limit time threshold THtb and the upper limit time threshold THtt are determined by at least one of the following:

Distance between the acoustic wave transmitter 20 and the acoustic wave receiver 30; and

Distance at which the ultrasonic beam propagates until the ultrasonic beam transmitted from the acoustic transmitter 20 is received by the acoustic wave receiver 30.

In the step S1112 (FIG. 13), the control circuit 32, after generating a received waveform data corresponding to the oscillation of the ultrasonic transducer 31 (FIG. 32), extracts the waveform WF2 to be referenced from among the waveform WF1˜WF3 included in the received waveform data by applying the time filter (e.g., time window Wt) to the received waveform data.

Control circuit 32 transmits the received waveform data including the extracted waveform WF2 to the temperature measuring apparatus 10.

### (3-10-2) Second Example of Modification 10

A second example of the modified example 10 will be described.

The temperature measuring apparatus 10 of the second example of the Modification 10 has the same time filter as that of the first example.

In the step S1113 (FIG. 13), the processor 12 extracts a waveform WF2 to be referred to from the waveform WF1˜WF3 included in the received waveform data by applying a time filter (e.g., a temporal window Wt) to the received waveform data.

### (4) Other Modifications

Other Modifications will be described.

The storage device 11 may be connected to the temperature measuring apparatus 10 via the network NW.

In the example of FIGS. 4A and 4B, an example of an acoustic wave receiver 30 comprising an ultrasonic transducer 31 is shown. However, the acoustic wave receiver 30 may include a plurality of ultrasonic transducers 31, similar to the acoustic wave transmitter 20.

In the example of FIG. 5, an example is shown in which one acoustic wave transmitter 20 transmits an ultrasonic beam along a plurality of paths and one acoustic wave receiver 30 receives the ultrasonic beam along a plurality of paths. However, the present embodiment is not limited to this. Each of the n (n is an integer of 2 or more) acoustic wave transmitters 20 may transmit an ultrasonic beam along one path (i.e., n acoustic wave transmitters 20 may transmit ultrasonic beams along n paths) and each of the n acoustic wave receivers 30 may receive the ultrasonic beam along each path (i.e., n acoustic wave receivers 30 may receive the ultrasonic beams along n paths).

In the above-described embodiment, an example in which functions for obtaining averages are used for calculating the mesh temperature TEMPmesh t has been described, but the method for calculating the mesh temperature TEMPmesh t of the present embodiment is not limited to this example.

The acoustic transmitter 20 may transmit an ultrasonic beam comprising an autocorrelation signal (e.g., an M-sequence signal) having a relatively strong autocorrelation. Thus, it is possible to further improve the S/N ratio of the measurement result of the temperature of the space.

The acoustic wave receiver 30 may identify the acoustic wave transmitter 20 that is the source of the ultrasonic beam by the acoustic wave transmitter 20 transmitting an ultrasonic beam comprising individually different autocorrelation signals.

Further, by transmitting the ultrasonic beam having a different oscillation frequency for each acoustic wave transmitter 20, the acoustic wave receiver 30 may identify the acoustic wave transmitter 20 that is the source of the ultrasonic beam.

The temperature measuring apparatus 10, in addition to the temperature distribution and wind vector distribution, it is also possible to measure the distribution of the following air characteristics:

Distributions of concentrations of airborne chemicals (e.g., CO₂)

Distribution of humidity

Odor distribution

Distribution of toxic gases

In the present embodiment, the acoustic wave transmitter 20 and the acoustic wave receiver 30 are defined separately, but the scope of the present embodiment is not limited to this. In the present embodiment, one ultrasonic transducer may have a function of transmitting ultrasonic wave and a function of receiving ultrasonic wave.

In the present embodiment, at least one of the equation used to calculate the path temperature TEMPpath i in the step S1114 (FIG. 13), and the equation used to calculate the mesh temperature TEMPmesh t in the step S112 (FIG. 12), may include the external environmental information (e.g., at least one of outside air temperature, outside air humidity, and the outside air pressure) as a parameter. In this case, regardless of the external environment information, it is possible to improve the S/N ratio of the measurement result of the air characteristics of the space.

In the present embodiment, an example is shown in which the acoustic wave transmitter 20 transmits an ultrasonic beam having directivity, but the present embodiment is not limited to this. This embodiment is also applicable when the acoustic wave transmitter 20 transmits an audible sound beam (i.e., an acoustic wave having a frequency different from that of the ultrasonic beam).

In the present embodiment, the temperature distribution is not limited to the mesh-temperature TEMPmesh. The temperature distribution also includes at least one of the following:

Temperature at multiple points on the path; and

Average temperature on the path

While embodiments of the present invention have been described in detail above, the scope of the present invention is not limited to the above embodiments. In addition, various modifications and changes can be made in the above embodiments without departing from the scope of the present invention. The above embodiments and modifications can be combined.

What is claimed is:

1. A measuring apparatus comprising:
a determining unit configured to determine propagation paths through which acoustic waves propagate, wherein the acoustic waves are transmitted from one or more transmitters, pass through a predetermined region and are received by one or more receivers;
a controlling unit configured to control the transmitters such that the acoustic waves are transmitted and propagate through the propagation paths determined by the determining unit;
an identifying unit configured to identify each of propagation times required for each of the acoustic waves transmitted in response to the control by the controlling unit to propagate each of the propagation paths; and
a measuring unit configured to measure an air characteristic of the predetermined region based on the propagation times identified by the identifying unit and length of the propagation paths.

2. The measuring apparatus of claim 1, wherein the measuring unit measures the air characteristic of the predetermined region by identifying propagation speed of the acoustic wave in the predetermined region based on the propagation times identified by the identifying unit and the length of the propagation paths.

3. The measuring apparatus of claim 1, further comprising an acquiring unit configured to acquire received waveform data relating to a waveform of the acoustic wave from the receiver which receives the acoustic wave transmitted in accordance with the control by the controlling unit, and wherein
the identifying unit identifies each of the propagation times required for propagation in each of the propagation paths based on the received waveform data acquired by the acquiring unit.

4. The measuring apparatus according to claim 3, further comprising an extracting unit configured to extract components corresponding to the acoustic wave propagated through a specific propagation path by applying a filter to the received waveform data acquired by the acquiring unit, and wherein
the identifying unit identifies the propagation time required for propagation through the specific propagation path based on the component extracted by the extracting unit.

5. The measuring apparatus of claim 1, wherein the measuring unit measures the air characteristics of the predetermined region using a time series filter.

6. The measuring apparatus of claim 1, wherein the length of the propagation path is determined based on a position of the transmitter and a position of the receiver.

7. The measuring apparatus of claim 1, wherein the propagation paths include a propagation path in which the acoustic wave transmitted from the transmitter is reflected by a reflection member and received by the receiver.

8. The measuring apparatus of claim 1, wherein the controlling unit controls a direction in which the acoustic wave is transmitted from the transmitter by changing a direction of the transmitter.

9. The measuring apparatus of claim 1, wherein the controlling unit controls a direction in which the acoustic wave is transmitted from the transmitter by oscillating transducers of the transmitter at different timings.

10. The measuring apparatus of claim 1, wherein the air characteristic includes air temperature.

11. The measuring apparatus of claim 1, wherein the air characteristic includes wind direction and intensity.

12. The measuring apparatus of claim 1, wherein the air characteristic includes at least one of a concentration of a substance in air, humidity, odor, and presence or absence of a toxic gas.

13. The measuring apparatus of claim 1, wherein the measuring apparatus is connectable to a first sensor unit and a second sensor unit,
the first sensor unit includes a first transmitter and a first receiver,
the second sensor unit includes a second transmitter and a second receiver, and
the propagation paths include a path through which the acoustic wave transmitted from the first transmitter is received by the second transmitter and a path through which the acoustic wave transmitted from the second transmitter is received by the first receiver.

14. The measuring apparatus of claim 1, wherein
the determining unit determines the propagation paths for each partial region included in a target space in which the transmitter and the receiver are arranged, the propagation paths passing the partial region, and
the measuring unit measures the air characteristic of each partial region based on the propagation times identified by the identifying unit and the length of the propagation paths.

15. A measuring method comprising:
determining propagation paths through which acoustic waves propagate, wherein the acoustic waves are transmitted from one or more transmitters, pass through a predetermined region and are received by one or more receivers;
controlling the transmitters such that the acoustic waves are transmitted and propagate through the determined propagation paths;
identifying each of propagation times required for each of the acoustic waves transmitted in response to the controlling of the transmitters to propagate each of the propagation paths; and
measuring an air characteristic of the predetermined region based on the identified propagation times and length of the propagation paths.

16. The measuring method of claim 15, wherein a time series filter is used to measure the air characteristic of the predetermined region.

17. The measuring method of claim 15, wherein the propagation paths include a propagation path in which the acoustic wave transmitted from the transmitter is reflected by a reflecting member and received by the receiver.

18. The measuring method of claim 15, wherein, in the controlling of the transmitter, a direction in which the acoustic wave is transmitted from the transmitter is controlled by changing a direction of the transmitter.

19. The measuring method of claim 15, wherein
the propagation paths are determined for each partial region included in a target space in which the transmitter and the receiver are arranged, the propagation paths passing the partial region,
the air characteristic of each partial region is measured based on the identified propagation times and the length of the propagation paths.

20. A non-transitory computer-readable storage medium storing a program that causes a computer to execute a measuring method, the measuring method comprising:
determining propagation paths through which acoustic waves propagate, wherein the acoustic waves are transmitted from one or more transmitters, pass through a predetermined region and are received by one or more receivers;
controlling the transmitters such that the acoustic waves are transmitted and propagate through the determined propagation paths;
identifying propagation times required for the acoustic waves transmitted in response to the controlling of the transmitter to propagate the propagation paths; and
measuring an air characteristic of the predetermined region based on the identified propagation times and length of the propagation paths.
